(19) United States
(12) Patent Application Publication
(10) Pub. No.: US 2008/0007116 A1
(43) Pub. Date: Jan. 10, 2008

(54) Brake control apparatus

(75) Inventors: Koji Takahashi, Kanagawa (JP); Yoshitaka Sugiyama, Kanagawa (JP); Katsuya Iwasaki, Kanagawa (JP); Yuki Nakada, Kanagawa (JP); Norihiro Saita, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/812,708

(22) Filed: Jun. 21, 2007

(30) Foreign Application Priority Data
Jun. 22, 2006 (JP) 2006-172922

(51) Int. Cl. B60T 8/00; G06F 19/00

(52) U.S. Cl. 303/113.3; 701/70

(57) ABSTRACT

In a brake control apparatus with wheel-brake cylinders mounted on respective road wheels, a pump is provided to supply a fluid pressure to each of the wheel-brake cylinders by normal rotation of the pump. A control unit is provided to control rotational motion of the pump to bring an actual wheel-cylinder pressure of each of the wheel-brake cylinders closer to a target wheel-cylinder pressure. Also provided is a pump reverse-rotation suppression device that suppresses reverse rotation of the pump, only when the reverse rotation of the pump is detected.

### TECHNICAL FIELD

The present invention relates to a brake control apparatus that controls a braking force by regulating each individual wheel-brake cylinder pressure, and specifically to a brake control apparatus capable of executing brake-by-wire (BBW) control.

### BACKGROUND ART

In recent years, there have been proposed and developed various automobile brake devices capable of executing brake-by-wire (BBW) control. One such BBW system equipped brake device has been disclosed in Japanese Patent No. 3409721 (hereinafter is referred to as “JP3409721”). In the brake device disclosed in JP3409721, a brake pedal is shut off from each individual wheel-brake cylinder, a master-cylinder pressure sensor is provided to detect a master-cylinder pressure, a stroke simulator is disposed between the brake pedal and the master cylinder, and a stroke sensor is provided to detect a depression stroke of the brake pedal. Target wheel-cylinder pressures are calculated based on sensor signal values from the stroke sensor and the master-cylinder pressure sensor. Required wheel-brake cylinder pressures are attained by controllably driving a pump motor and electromagnetic valves based on the calculated target wheel-cylinder pressures.

### SUMMARY OF THE INVENTION

In a so-called brake-by-wire (BBW) system capable of attaining a wheel-cylinder pressure build-up mode by means of a brake-fluid pressure pump, when mode-switching from pressure-buildup to pressure-reduction occurs or when mode-switching from pressure-buildup to pressure-hold occurs, a residual pressure tends to stay in the pump discharge side (a pump outlet). Owing to the residual pressure, working-fluid backflow (reverse flow) from the pump discharge side to the pump suction side (a pump inlet) occurs. Thus, the pump begins to rotate in a reverse-rotational direction and as a result the working-fluid pressure in the pump discharge side becomes negative (less than atmospheric pressure). When restarting the buildup of discharge pressure of the pump, a surplus pressure buildup operation covering the negative pressure at the pump discharge side must be made. This results in a discharge response delay in the pump.

One way to avoid the previously-discussed undesirable working-fluid backflow (pump backflow) is to continuously apply electricity to the pump motor in such a manner as to rotate the pump in a normal-rotational direction, even during a mode transition from pressure-buildup to pressure-reduction. In such a case, electricity (electric current) has to be wastefully applied to the pump motor, even when the working-fluid pressure in the pump discharge side is positive and thus there is no risk of pump backflow. This leads to the problem of increased electricity consumption.

It is, therefore, in view of the previously-described disadvantages of the prior art, an object of the invention to provide a brake control apparatus capable of improving a pump discharge response while reducing electric current unnecessarily applied to a pump motor during a pressure reduction mode.

In order to accomplish the aforementioned and other objects of the present invention, a brake control apparatus comprises wheel-brake cylinders mounted on respective road wheels, a pump that supplies a fluid pressure to each of the wheel-brake cylinders by normal rotation of the pump, a control unit that controls rotational motion of the pump to bring an actual wheel-cylinder pressure of each of the wheel-brake cylinders closer to a target wheel-cylinder pressure, and a pump reverse-rotation suppression device that suppresses reverse rotation of the pump.

According to another aspect of the invention, a brake control apparatus employing a tandem master cylinder and a pair of hydraulic units, each hydraulic unit having a pump producing a fluid pressure independently of the master cylinder, a hydraulic circuit having a first flow path communicating an associated one of two port outlets of the master cylinder with an associated one of front wheel-brake cylinders via a first directional control valve and a second flow path introducing the fluid pressure produced by the pump to an associated one of rear wheel-brake cylinders as well as the associated one of the front wheel-brake cylinders directly via a second directional control valve, the brake control apparatus comprising a control unit that switches between a first fluid-pressure supply that a master-cylinder pressure is supplied from the master cylinder to the associated front wheel-brake cylinder via the first directional control valve and a second fluid-pressure supply that the fluid pressure produced by normal rotation of the pump is supplied to the associated wheel-brake cylinders directly via the second directional control valve, by controlling open and closed operation of each of the first and second directional control valves, and a pump reverse-rotation suppression device that suppresses reverse rotation of the pump.

According to a further aspect of the invention, a brake control method comprises providing a first fluid-pressure supply mode at which a master-cylinder pressure, produced based on a driver's brake-pedal depression, is supplied from a master cylinder to each of front wheel-brake cylinders, providing a second fluid-pressure supply mode at which a fluid pressure produced by normal rotation of a pump, which pump produces the fluid pressure independently of the master cylinder, is supplied to an associated one of rear wheel-brake cylinders as well as an associated one of the front wheel-brake cylinders, selectively switching from one of the first and second fluid-pressure supply modes to the other depending on whether a brake system is failed or unfailed, and engaging a pump reverse-rotation suppressing function that suppresses reverse rotation of the pump by suppressing working-fluid flow from each of the wheel-brake cylinders to a pump suction side, only when the reverse rotation of the pump occurs.

The other objects and features of this invention will become understood from the following description with reference to the accompanying drawings.

### BRIEF DESCRIPTION OF THE DRAWINGS

FIG. 1 is a system diagram illustrating an embodiment of a brake control apparatus.

FIG. 2 is a hydraulic circuit diagram illustrating a first hydraulic unit.

FIG. 3 is a hydraulic circuit diagram illustrating a second hydraulic unit.

FIG. 4 is a flow chart illustrating a brake-by-wire control routine.

FIG. 5 is a flow chart illustrating a valve opening/closing control routine for a stroke-simulator cutoff valve.

FIG. 6 is a motor control block diagram showing motor control executed within first and second sub-ECUs.

FIG. 7 is a main flow chart illustrating a pump backflow prevention control routine based on motor speed control, executed by the control system of the embodiment.

FIG. 8 is a flow chart illustrating a motor speed calculation routine related to step S200 of FIG. 7.

FIG. 9 is a flow chart illustrating a motor speed control routine related to step S300 of FIG. 7.

FIGS. 10A-10C are time charts illustrating several characteristics obtained with no execution of pump backflow prevention control.

FIGS. 11A-11C are time charts illustrating several characteristics obtained with execution of pump backflow prevention control.

FIG. 12 is a modified motor control block diagram.

FIG. 13 is a time chart illustrating a change in pump discharge pressure, which varies with time t, in the presence of pump reverse-rotation and in the absence of pump reverse-rotation.

FIG. 14 is a pump discharge-pressure falling gradient ΔPp calculation map.

FIG. 15 is a main flow chart illustrating a pump backflow prevention control routine based on pump discharge pressure control, executed by the modified control system of FIG. 12.

FIG. 16 is a pump discharge-pressure falling gradient calculation routine related to step S600 of FIG. 15 and executed within the modified motor control system shown in FIG. 12.

FIG. 17 is a pump discharge pressure control routine related to step S700 of FIG. 15 and executed within the modified motor control system shown in FIG. 12.

FIG. 18 is a modification in which a pump-backflow-prevention check valve (or a pump-backflow-suppression check valve) is disposed in the pump suction line.

FIG. 19 is another modification in which an integrated controller is combined with the brake control apparatus of the embodiment.

### DESCRIPTION OF THE PREFERRED EMBODIMENTS

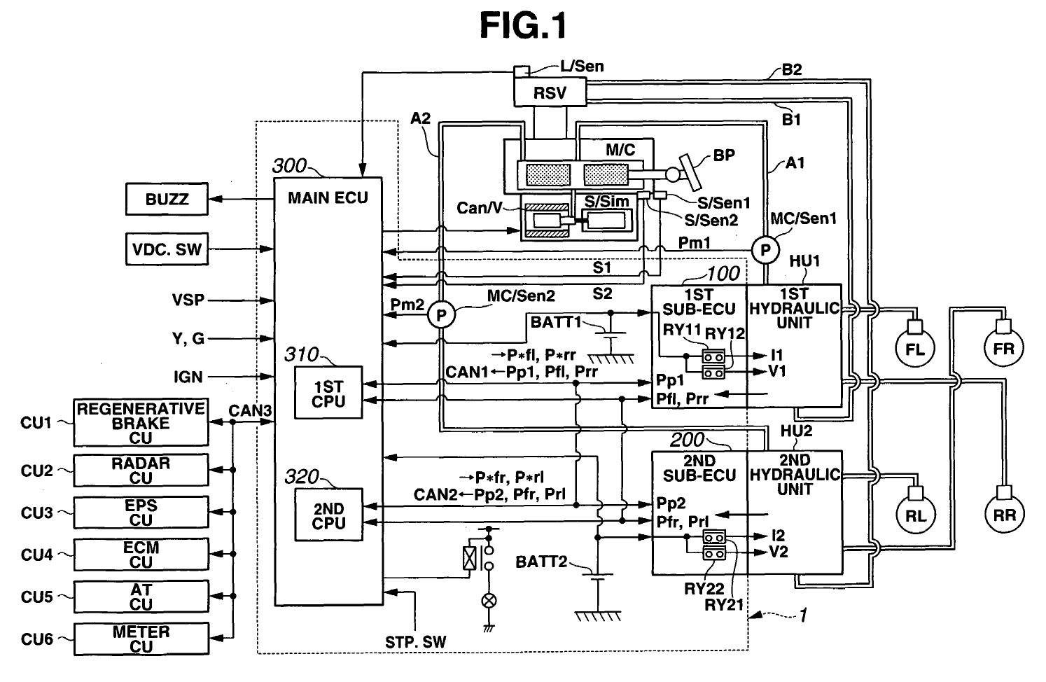

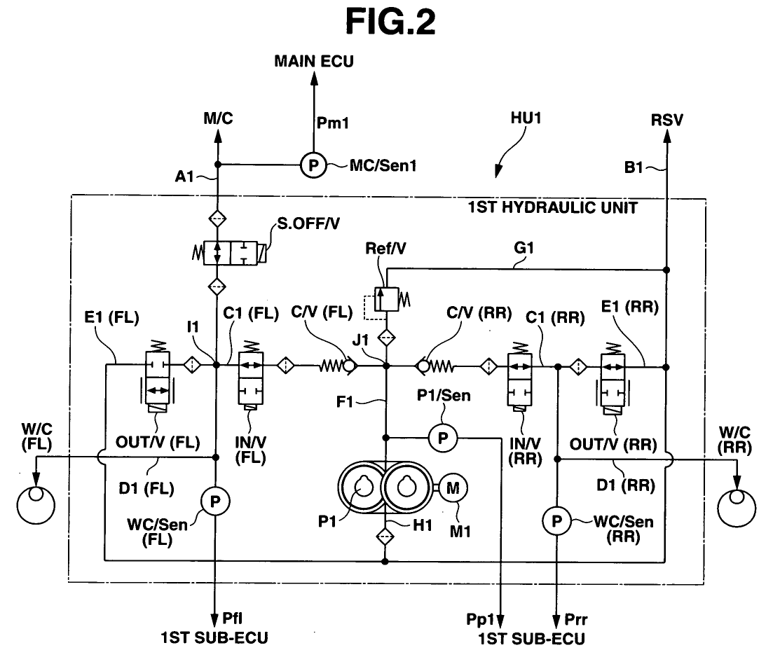

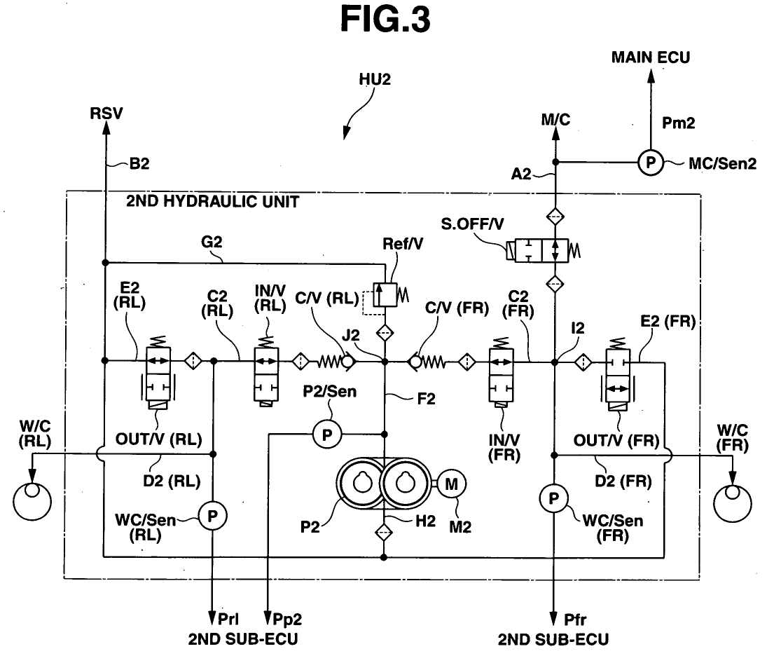

Referring now to the drawings, particularly to FIG. 1, there is shown the brake control system configuration of the brake control apparatus of the embodiment. The brake control apparatus of FIG. 1 is exemplified in a four-wheel brake-by-wire (BBW) system equipped brake device employing a first hydraulic unit HU1 and a second hydraulic unit HU2 capable of controlling or regulating brake fluid pressures (or wheel-brake cylinder pressures) independently of a manipulation (a depression) of a brake pedal BP by the driver. 1^{st} and 2^{nd} hydraulic units HU1-HU2 are driven by means of respective sub-electronic control units (sub-ECUs) 100 and 200 responsively to a command signal from a main electronic control unit (main ECU) 300. A reaction force. applied to brake pedal BP is created by means of a stroke simulator S/Sim connected to a master cylinder M/C. 1^{st} hydraulic unit HU1 is connected via a fluid line A1 to a first port of master cylinder M/C, whereas 2^{nd} hydraulic unit HU2 is connected via a fluid line A2 to a second port of master cylinder M/C. Master cylinder M/C is a tandem master cylinder with two pistons set in tandem. Also, 1^{st} hydraulic unit HU1 is connected via a fluid line B1 to a brake-fluid reservoir RSV, whereas 2^{nd} hydraulic unit HU2 is connected via a fluid line B2 to reservoir RSV. A first master-cylinder (M/C) pressure sensor MC/Sen1 is provided or screwed into the fluid line A1, whereas a second master-cylinder (M/C) pressure sensor MC/Sen2 is provided or screwed into the fluid line A2. 1^{st} hydraulic unit HU1 is comprised of a pump P1, a motor M1, and electromagnetic valves (see FIG. 2). In a similar manner, 2^{nd} hydraulic unit HU2 is comprised of a pump P2, a motor M2, and electromagnetic valves (see FIG. 3). 1^{st} and 2^{nd} hydraulic units HU1-HU2 are configured as hydraulic actuators (hydraulic modulators) capable of generating fluid pressures independently of each other. 1^{st} hydraulic unit HU1 is used for fluid-pressure control of wheel-cylinder pressures of a front-left road wheel FL and a rear-right road wheel RR. 2^{nd} hydraulic unit HU2 is used for fluid-pressure control of wheel-cylinder pressures of a front-right road wheel FR and a rear-left road wheel RL. That is, wheel-cylinder pressures of wheel-brake cylinders W/C(FL)-W/C(RR) can be directly built up by means of pumps P1-P2, serving as two different fluid-pressure sources, each producing a fluid pressure independently of master cylinder M/C (a pressure source during a manual brake mode). It is possible to build up the wheel-cylinder pressures directly by these pumps P1-P2 without using any pressure accumulators, and thus there is no risk of undesirable blending (leakage) of gas in the accumulator into working fluid in the fluid lines in the presence of a brake system failure. As discussed above, pump P1 functions to build up wheel-cylinder pressures of a first pair of diagonally-opposed road wheels, namely, front-left and rear-right road wheels FL and RR, whereas pump P2 functions to build up wheel-cylinder pressures of a second pair of diagonally-opposed road wheels, namely, front-right and rear-left road wheels FR and RL. That is, pumps P1-P2 are provided to construct a so-called diagonal split layout of brake circuits, sometimes termed “X-split layout”. 1^{st} hydraulic unit HU1 and 2^{nd} hydraulic unit HU2 are configured to be separated from each other. By the use of the two separate hydraulic units HU1-HU2, even if there is a leakage of working fluid from either one of 1^{st} and 2^{nd} hydraulic units HU1-HU2, it is possible to certainly produce a braking force by the other unfailed hydraulic unit. As set forth above, 1^{st} and 2^{nd} hydraulic units HU1-HU2 are configured as separate units, but it is preferable that these hydraulic units HU1-HU2 are integrally connected to each other. This is because electric circuit configurations can be gathered to one place. This contributes to shortened harness lengths and simplified brake system layout.

From the viewpoint of the more compact brake system configuration, on the one hand, it is desirable to reduce the number of fluid-pressure sources. On the other hand, in case of the use of a single brake-fluid pressure source (only one fluid-pressure pump), there will not be any backup fluid-pressure source. In contrast, assuming that four fluid-pressure sources are provided at respective road wheels FL, FR, RR, and RL, this is advantageous with respect to enhanced fail-safe performance but leads to the problem of a large-sized brake system and more complicated brake system control. Generally, it is necessary to further incorporate a redundant system in case of brake-by-wire control. There is a risk of divergence of the system owing to the increased fluid-pressure sources.

Recently, as a general layout of brake circuits, a so-called diagonal split layout of brake circuits, sometimes termed “X-split layout” is used. In the usual “X-split layout”, one of two different fluid-pressure sources (e.g., one part of the tandem master cylinder output) is connected via a first brake circuit to front-left and rear-right wheel-brake cylinders W/C(FL) and W/C(RR) and the other fluid-pressure source (e.g., the other part of the tandem master cylinder output) is connected via a second brake circuit to front-right and rear-left wheel-brake cylinders W/C(FR) and W/C(RL), so as to be able to independently build up the first and second brake systems by means of the respective fluid-pressure sources (e.g., the two port outputs of the tandem master cylinder). By virtue of the use of the X-split layout, for instance, assuming that the brake circuit associated with front-left wheel-brake cylinder W/C(FL) is failed, the brake circuit associated with rear-right wheel-brake cylinder W/C(RR) becomes failed simultaneously, and thus the system permits simultaneous braking force application to both of the front-right and rear-left road wheels by the unfailed brake circuit (the second brake circuit). Conversely assuming that the brake circuit associated with front-right wheel-brake cylinder W/C(FR) is failed, the brake circuit associated with rear-left wheel-brake cylinder W/C(RL) becomes failed simultaneously, and thus the system permits simultaneous braking force application to both of the front-left and rear-right road wheels by the unfailed brake circuit (the first brake circuit). Therefore, such an X-split layout is superior in braking-force balance of the vehicle even when either one of the first brake circuit (the 1^{st} fluid-pressure source P1) associated with front-left and rear-right wheel-brake cylinders W/C(FL) and W/C(RR) and the second brake circuit (the 2^{nd} fluid-pressure source P2) associated with front-right and rear-left wheel-brake cylinders W/C(FR) and W/C(RL) is failed. The use of X-split layout contributes to the enhanced braking-force balance of the vehicle. As a prerequisite for the X-split layout, the number of fluid-pressure sources must be two.

For the reasons discussed above, in case of the use of only one fluid-pressure source, it is impossible to provide an “X-split layout”. In case of the use of three fluid-pressure sources respectively associated with front-left wheel FL, front-right wheel FR, and rear wheels RL-RR or in case of the use of four fluid-pressure sources associated with respective road wheels FL, FR, RL, and RR, it is impossible to connect diagonally-opposed road wheels with the same fluid-pressure source.

Therefore, the brake apparatus of the present embodiment is configured or designed to construct a dual fluid-pressure source system by way of 1^{st} and 2^{nd} hydraulic units HU1-HU2 having respective pumps P1-P2 serving as two separate fluid-pressure sources, in order to enhance a fail-safe performance without changing the widespread or widely-used “X-split layout”.

As is generally known, owing to a wheel load shift during braking, a front wheel load tends to become greater than a rear wheel load, and thus a rear-wheel braking force is not so great. Additionally, there is a possibility of a rear wheel spin in case of an excessive rear-wheel braking force. For the reasons discussed above, for a general braking force distribution between front and rear road wheels, a front-wheel braking force is designed to be greater than a rear-wheel braking force. For instance, the ratio of front-wheel braking force to rear-wheel braking force is 2:1.

Suppose that a multiple fluid-pressure source system is utilized to enhance the fail-safe performance and thus a plurality of hydraulic units are mounted on the vehicle. In such a case, from the viewpoint of reduced costs, it is desirable to mount the hydraulic units having the same specification on the vehicle. However, assuming that fluid-pressure sources are provided for all of four road wheels, from the viewpoint of a braking force distribution between front and rear wheels, two sorts of hydraulic units, having respective specifications differing from each other, must be prepared for front and rear wheels. This means increased manufacturing costs. In case of the system having three fluid-pressure sources, the same problem (the increased costs) occurs, because of a front-and-rear wheel braking force distribution, that is, setting of a greater front-wheel braking force and a smaller rear-wheel braking force.

For the reasons discussed above, in the brake control apparatus of the embodiment, two hydraulic units HU1-HU2, having the same specification, are utilized and configured to provide an “X-split layout”. Note that, in the hydraulic circuits of hydraulic units HU1-HU2, the valve openings are preset such that the ratio of a fluid pressure for front wheels FL, FR to a fluid pressure for rear wheels RL, RR is 2:1. In this manner, by installing two hydraulic units HU1-HU2, having the same specification, on the vehicle, it is possible to realize the front-and-rear wheel braking force distribution of 2:1, while achieving an inexpensive dual fluid-pressure source system.

[MAIN ECU]

Main ECU 300 is a broader central processing unit (CPU) that calculates a target front-left wheel-cylinder pressure P*fl and a target rear-right wheel-cylinder pressure P*rr for 1^{st} hydraulic unit HU1 and also calculates a target front-right wheel-cylinder pressure P*fr and a target rear-left wheel-cylinder pressure P*rl for 2^{nd} hydraulic unit HU2. Main ECU 300 is connected to both of a first electric power source BATT1 and a second electric power source BATT2, in such a manner as to be able to operate, if at least one of power sources BATT1-BATT2 is operating normally. Main ECU 300 is started responsively to an ignition switch signal IGN from an ignition switch or responsively to an ECU starting requirement from each of control units CU1 to CU6, each of which is connected via a controller area network (CAN) communications line CAN3 to main ECU 300.

The input interface circuitry of main ECU 300 receives a stroke signal S1 from a first stroke sensor S/Sen1, a stroke signal S2 from a second stroke sensor S/Sen2, a master-cylinder pressure signal from 1^{st} master-cylinder pressure sensor MC/Sen1 indicative of a first master-cylinder pressure Pm1, and a master-cylinder pressure signal from 2^{nd} master-cylinder pressure sensor MC/Sen2 indicative of a second master-cylinder pressure Pm2. As used hereafter, 1^{st} and 2^{nd} master-cylinder pressures Pm1-Pm2 are collectively referred to as “master-cylinder pressure Pm”. The input interface circuitry of main ECU 300 also receives a vehicle speed sensor signal indicative of vehicle speed VSP, a yaw rate sensor signal indicative of yaw rate Y, and a longitudinal-G sensor signal indicative of longitudinal acceleration G. Furthermore, the input interface circuitry of main ECU 300 receives a sensor signal from a brake-fluid quantity sensor L/Sen that detects a quantity of brake fluid in brake-fluid reservoir RSV. On the basis of the detected value of brake-fluid quantity sensor L/Sen, it is determined whether or not brake-by-wire (BBW) control is executable by driving pumps P1-P2. The input interface circuitry of main ECU 300 also receives a sensor signal from a stop lamp switch STP.SW, so as to detect a manipulation (a depression) of brake pedal BP by the driver, without using stroke signals S1-S2 and master-cylinder pressures Pm1-Pm2.

Two central processing units (CPUs), that is, 1^{st} CPU 310 and 2^{nd} CPU 320, are provided in main ECU 300 for arithmetic calculations. 1^{st} CPU 310 is connected to 1^{st} sub-ECU 100 via a CAN communications line CAN1, whereas 2^{nd} CPU 320 is connected to 2^{nd} sub-ECU 200 via a CAN communications line CAN2. Signals, respectively indicating pump discharge pressure Pp1 discharged from 1^{st} pump P1, and actual front-left and rear-right wheel-cylinder pressures Pfl and Prr, are input via 1^{st} sub-ECU 100 into 1^{st} CPU 310. Signals, respectively indicating pump discharge pressure Pp2 discharged from 2^{nd} pump P2, and actual front-right and rear-left wheel-cylinder pressures Pfr and Prl, are input via 2^{nd} sub-ECU 200 into 2^{nd} CPU 320. These CAN communications lines CAN1-CAN2 are connected to each other for the purpose of a dual backup network communications system.

On the basis of the input information, such as stroke signals S1-S2, master-cylinder pressures Pm1-Pm2, and actual wheel-brake cylinder pressures Pfl, Pfr, Prl, and Prr, 1^{st} CPU 310 calculates target front-left wheel-cylinder pressure P*fl and target rear-right wheel-cylinder pressure P*rr to generate the calculated target wheel-cylinder pressures P*fl and P*rr via the 1^{st} CAN communications line CAN1 to 1^{st} sub-ECU 100, while 2^{nd} CPU 320 calculates target front-right wheel-cylinder pressure P*fr and target rear-left wheel-cylinder pressure P*rl to generate the calculated target wheel-cylinder pressures P*fr and P*rl via the 2^{nd} CAN communications line CAN2 to 2^{nd} sub-ECU 200. In lieu thereof, the four target wheel-cylinder pressures P*fl to P*rr for 1^{st} and 2^{nd} hydraulic units HU1-HU2 may be all calculated within 1^{st} CPU 310, whereas 2^{nd} CPU 320 may be used as a backup CPU for 1^{st} CPU 310.

Main ECU 300 functions to start up each of 1^{st} and 2^{nd} sub-ECUs 100-200 via CAN communications lines CAN1-CAN2. In the shown embodiment, main ECU 300 generates two command signals for starting up respective sub-ECUs 100-200 independently of each other. In lieu thereof, sub-ECUs 100-200 may be started up simultaneously in response to a single command signal from main ECU 300. Alternatively, sub-ECUs 100-200 may be started up simultaneously in response to ignition switch signal IGN.

During execution of vehicle dynamic-behavior control including anti-skid brake control (often abbreviated to “ABS”, which is executed for increasing or decreasing a braking force for wheel-lock prevention), vehicle dynamics control (often abbreviated to “VDC”, which is executed for increasing or decreasing a braking force to prevent side slip occurring due to instable vehicle behaviors), traction control (often abbreviated to “TCS”, which is executed for acceleration-slip suppression of drive wheels), and the like, input information, such as vehicle speed VSP, yaw rate Y, and longitudinal acceleration G, is further extracted, for executing fluid-pressure control concerning target wheel-cylinder pressures P*fl, P*fr, P*rl, and P*rr. During the vehicle dynamics control (VDC), a warning buzzer BUZZ emits a buzzing sound cyclically to warn the driver or vehicle occupants that the VDC system comes into operation. A VDC switch VDC.SW, serving as a man-machine interface, is also provided so as to manually engage or disengage the VDC function via the VDC switch VDC.SW in accordance with the driver's wishes.

Main ECU 300 is also connected to the other control units CU1 to CU6 via CAN communications line CAN3 for cooperative control. For energy regeneration, the regenerative brake control unit CU1 is provided to return a braking force to an electric supply system by way of conversion from kinetic energy into electric energy. The radar control unit CU2 is provided for vehicle-to-vehicle distance control. The EPS control unit CU3 serves as a control unit for an electrically-operated (motor-driven) power steering system.

The ECM control unit CU4 is an engine control unit, the AT control unit CU5 is an automatic transmission control unit, and the meter control unit CU6 is provided to control each of meters. The input information indicative of vehicle speed VSP, input into main ECU 300, is generated via CAN communications line CAN3 into each of ECM control unit CU4, AT control unit CU5, and meter control unit CU6.

1^{st} and 2^{nd} power sources BATT1-BATT2 correspond to electric power sources for ECUs 100, 200, and 300. Concretely, 1^{st} power source BATT1 is connected to main ECU 300 and 1^{st} sub-ECU 100, whereas 2^{nd} power source BATT2 is connected to main ECU 300 and 2^{nd} sub-ECU 200.

[SUB-ECUS]

In the shown embodiment, 1^{st} sub-ECU 100 is formed integral with 1^{st} hydraulic unit HU1, whereas 2^{nd} sub-ECU 200 is formed integral with 2^{nd} hydraulic unit HU2. Depending upon the type of vehicle or the required layout, 1^{st} sub-ECU 100 and 1^{st} hydraulic unit HU1 may be formed separately from each other, whereas 2^{nd} sub-ECU 200 and 2^{nd} hydraulic unit HU2 may be formed separately from each other.

In the shown embodiment, 1^{st} sub-ECU 100 receives input informational signals, generated from main ECU 300 and indicating target wheel-cylinder pressures P*fl and P*rr, and also receives input informational signals, generated from 1^{st} hydraulic unit HU1 and indicating pump discharge pressure Pp1 discharged from 1^{st} pump P1 and actual front-left and rear-right wheel-cylinder pressures Pfl and Prr. In a similar manner, 2^{nd} sub-ECU 200 receives input informational signals, generated from main ECU 300 and indicating target wheel-cylinder pressures P*fr and P*rl, and also receives input informational signals, generated from 2^{nd} hydraulic unit HU2 and indicating pump discharge pressure Pp2 discharged from 2^{nd} pump P2 and actual front-right and rear-left wheel-cylinder pressures Pfr and Prl.

On the basis of the latest up-to-date informational data (more recent data) about pump discharge pressures Pp1-Pp2 and actual wheel-cylinder pressures Pfl-Prr, the fluid-pressure control is performed to realize target wheel-cylinder pressures P*fl-P*rr by driving the electromagnetic valves and motors M1-M2 for pumps P1-P2 incorporated in the respective hydraulic units HU1-HU2.

The previously-noted 1^{st} sub-ECU 100 constructs a servo control system that continuously executes fluid-pressure control for front-left and rear-right wheels FL and RR, based on the previous values concerning target wheel-cylinder pressure inputs P*fl and P*rr in such a manner as to bring or converge actual wheel-cylinder pressures Pfl and Prr closer to these previous values, until new target values are inputted. In a similar manner, the previously-noted 2^{nd} sub-ECU 200 constructs a servo control system that continuously executes fluid-pressure control for front-right and rear-left wheels FR and RL, based on the previous values concerning target wheel-cylinder pressure inputs P*fr and P*rl in such a manner as to bring or converge actual wheel-cylinder pressures Pfr and Prl closer to these previous values, until new target values are inputted.

By means of 1^{st} sub-ECU 100, electric power from 1^{st} power source BATT1 is converted into a valve driving current I1 and a motor driving voltage V1 of 1^{st} hydraulic unit HU1, and then the converted valve driving current I1 and motor driving voltage V1 are relayed through respective relays RY11-RY12 to 1^{st} hydraulic unit HU1. In a similar manner, by means of 2^{nd} sub-ECU 200, electric power from 2^{nd} power source BATT2 is converted into a valve driving current I2 and a motor driving voltage V2 of 2^{nd} hydraulic unit HU2, and then the converted valve driving current I2 and motor driving voltage V2 are relayed through respective relays RY21-RY22 to 2^{nd} hydraulic unit HU2.

[Target Values Calculation for Hydraulic Units and Driving Current/Voltage Control, Separated from Each Other]

As previously discussed, main ECU 300 is configured to execute arithmetic processing for target values P*fl-P*rr for 1^{st} and 2^{nd} hydraulic units HU1-HU2, but not configured to execute the previously-noted driving current/voltage control concerning valve driving currents I1-I2 and motor driving voltages V1-V2. Assuming that main ECU 300 is configured to execute the driving current/voltage control as well as the target wheel-cylinder pressure calculations, main ECU 300 must generate driving command signals to 1^{st} and 2^{nd} hydraulic units HU1-HU2 according to cooperative control with the other control units CU1-CU6 by way of controller area network (CAN) communications and the like. In such a case, target wheel-cylinder pressures P*fl to P*rr are outputted after arithmetic operations of CAN communications line CAN3 and the other control units CU1-CU6 have terminated. On the assumption that a transmission speed of CAN communications line CAN3 and operation speeds of the other control units CU1-CU6 are slow, there is an undesirable response delay in fluid-pressure control (brake control). One way to avoid such an undesirable response delay is to increase the transmission speed of each of communications lines needed for connections with the other controllers installed inside of the vehicle. However, this leads to another problem of increased costs. Additionally, a deterioration in fail-safe performance occurs owing to noise caused by the increased transmission speed.

For the reasons discussed above, in the shown embodiment, the role of main ECU 300 is limited to arithmetic operations of target wheel-cylinder pressures P*fl to P*rr, and additionally driving control for 1^{st} and 2^{nd} hydraulic units HU1-HU2 is performed by 1^{st} and 2^{nd} sub-ECUs 100-200 each constructing the servo control system.

With the previously-noted arrangement, 1^{st} and 2^{nd} sub-ECUs 100-200 specialize in driving control for 1^{st} and 2^{nd} hydraulic units HU1-HU2, while cooperative control with the other control units CU1-CU6 is performed by main ECU 300. Thus, it is possible to execute fluid-pressure control (brake control) without being affected by several factors, i.e., the transmission speed of CAN communications line CAN3 and operation speeds of control units CU1-CU6.

Therefore, even when an integrated controller for a regenerative cooperative brake system needed for a hybrid vehicle (HV) or a fuel-cell vehicle (FCV), an integrated vehicle control system, and/or an intelligent transport system (ITS) is further added, it is possible to ensure or realize a high brake control responsiveness while smoothly planning fusion with these additional units/systems, by independently controlling the brake control system separately from the other control systems.

The BBW system equipped brake control apparatus of the embodiment, requires very precise, fine fluid-pressure control suited to a manipulated variable (a depression stroke) of brake pedal BP, during normal braking operations, frequently performed. Thus, separating arithmetic operations of target wheel-cylinder pressures P*fl to P*rr for hydraulic units HU1-HU2 from driving control for hydraulic units HU1-HU2 is very effective and advantageous.

[Master Cylinder and Stroke Simulator]

Stroke simulator S/Sim is built in master cylinder M/C and provided to generate a reaction force of brake pedal BP. Also provided in master cylinder M/C is a stroke-simulator cutoff valve Can/V for establishing or blocking fluid communication between master cylinder M/C and stroke simulator S/Sim.

Open and closed operation of stroke-simulator cutoff valve Can/V is controlled by means of main ECU 300, such that rapid switching to a manual brake mode occurs upon termination of brake-by-wire control or when at least one of sub-ECUs 100-200 becomes failed. As previously described, 1^{st} and 2^{nd} stroke sensors S/Sen1-S/Sen2 are provided at the master cylinder M/C. Two stroke signals S1-S2, each indicating a stroke of brake pedal BP, are generated from respective stroke sensors S/Sen1-S/Sen2 to main ECU 300.

[Hydraulic Units]

Referring now to FIG. 2, there is shown the hydraulic circuit diagram of 1^{st} hydraulic unit HU1. Components incorporated in 1^{st} hydraulic unit HU1 are electromagnetic valves (directional control valves), pump P1, and motor M1. The electromagnetic valves are constructed by a shutoff valve S.OFF/V, a front-left inflow valve IN/V(FL), a rear-right inflow valve IN/V(RR), a front-left outflow valve OUT/V(FL), and a rear-right outflow valve OUT/V(RR). The valve openings of these valves S.OFF/V, IN/V(FL), IN/V(RR), OUT/V(FL), and OUT/V(RR) are preset such that the ratio of a fluid pressure for front wheels FL, FR to a fluid pressure for rear wheels RL, RR is 2:1.

A discharge line (a pump outlet line) F1 of pump P1 is connected through a fluid line C1(FL) to front-left wheel cylinder W/C(FL). Discharge line F1 is also connected through a fluid line C1(RR) to rear-right wheel cylinder W/C(RR). A suction line (a pump inlet line) H1 of pump P1 is connected through fluid line B1 to reservoir RSV. Fluid line C1(FL) is connected through a fluid line E1(FL) to fluid line B1, whereas fluid line C1(RR) is connected through a fluid line E1(RR) to fluid line B1.

A joining point I1 of fluid line C1(FL) and fluid line E1(FL) is connected through fluid line A1 to master cylinder M/C. Furthermore, a joining point J1 of fluid line C1(FL) and fluid line C1(RR) is connected through a fluid line G1 to fluid line B1.

Shutoff valve S.OFF/V is comprised of a normally-open electromagnetic valve, and fluidly disposed in fluid line A1 for establishing or blocking fluid communication between master cylinder M/C and joining point I1.

Front-left inflow valve IN/V(FL) is fluidly disposed in fluid line C1(FL), and comprised of a normally-open proportional control valve that regulates the discharge pressure produced by pump P1 by way of proportional control action and then supplies the proportional-controlled fluid pressure to front-left wheel cylinder W/C(FL). Similarly, rear-right inflow valve IN/V(RR) is fluidly disposed in fluid line C1(RR), and comprised of a normally-open proportional control valve that regulates the discharge pressure produced by pump P1 by way of proportional control action and then supplies the proportional-controlled fluid pressure to rear-right wheel cylinder W/C(RR). Backflow-prevention check valves C/V(FL)-C/V(RR) are fluidly disposed in respective fluid lines C1(FL)-C1(RR) to prevent working fluid from flowing back to the discharge port of pump P1.

Front-left and rear-right outflow valves OUT/V(FL)-OUT/V(RR) are fluidly disposed in respective fluid lines E1(FL)-E1(RR). Front-left outflow valve OUT/V(FL) is comprised of a normally-closed proportional control valve, whereas rear-right outflow valve OUT/V(RR) is comprised of a normally-open proportional control valve. A relief valve Ref/V is fluidly disposed in fluid line G1.

1^{st} M/C pressure sensor MC/Sen1 is provided or screwed into fluid line A1 interconnecting 1^{st} hydraulic unit HU1 and master cylinder M/C, for detecting 1^{st} master-cylinder pressure Pm1 and for generating a signal indicative of the detected 1^{st} master-cylinder pressure to main ECU 300. Front-left and rear-right wheel-cylinder pressure sensors WC/Sen(FL)-WC/Sen(RR) are incorporated into 1^{st} hydraulic unit HU1 and provided or screwed into respective fluid lines C1(FL)-C1(RR), for detecting actual front-left and rear-right wheel-cylinder pressures Pfl and Prr. A first pump discharge pressure sensor P1/Sen is provided or screwed into discharge line F1 for detecting discharge pressure Pp1 discharged from 1^{st} pump P1. Signals indicative of the detected values Pfl, Prr, and Pp1 are generated from the respective sensors WC/Sen(FL)-WC/Sen(RR) and P1/Sen to 1^{st} sub-ECU 100.

[Normal Braking]

(During Pressure Buildup)

During normal braking at a pressure buildup mode, shutoff valve S.OFF/V is kept closed, inflow valves IN/V(FL)-IN/V(RR) are kept open, outflow valves OUT/V(FL)-OUT/V(RR) are kept closed, and motor M1 is rotated. Thus, pump P1 is driven by motor M1, and thus a discharge pressure is supplied from pump P1 through discharge line F1 to fluid lines C1(FL)-C1(RR). Then, the regulated working fluid, proportional-controlled by front-left inflow valve IN/V(FL), is introduced from inflow valve IN/V(FL) via a fluid line D1(FL) into front-left wheel cylinder W/C(FL). Likewise, the regulated working fluid, proportional-controlled by rear-right inflow valve IN/V(RR), is introduced from inflow valve IN/V(RR) via a fluid line D1(RR) into rear-right wheel cylinder W/C(RR). In this manner, a pressure buildup mode can be achieved.

(During Pressure Reduction)

During normal braking at a pressure reduction mode, inflow valves IN/V(FL)-IN/V(RR) are kept closed, while outflow valves OUT/V(FL)-OUT/V(RR) are kept open. Thus, front-left and rear-right wheel-cylinder pressures Pfl-Prr are exhausted through outflow valves OUT/V(FL)-OUT/V(RR) via fluid line B1 into reservoir RSV.

(During Pressure Hold)

During normal braking at a pressure hold mode, inflow valves IN/V(FL)-IN/V(RR) and outflow valves OUT/V(FL)-OUT/V(RR) are all kept closed, so as to hold or retain front-left and rear-right wheel-cylinder pressures Pfl-Prr unchanged.

[Manual Brake]

When the operating mode of the BBW system equipped brake control apparatus has been switched to a manual brake mode owing to a system failure, shutoff valve S.OFF/V becomes open, and inflow valves IN/V(FL)-IN/V(RR) become closed. As a result of this, master-cylinder pressure Pm is not delivered to rear-right wheel cylinder W/C(RR). On the other hand, front-left outflow valve OUT/V(FL) is comprised of a normally-closed valve and therefore the outflow valve OUT/V(FL) is kept closed during the manual brake mode. Front-left wheel cylinder W/C(FL) becomes conditioned in a master-cylinder pressure application state. Thus, master-cylinder pressure Pm, built up by the driver's brake-pedal depression, can be applied to front-left wheel cylinder W/C(FL). In this manner, the manual brake mode can be achieved or ensured.

Suppose that master-cylinder pressure Pm is applied to rear-right wheel cylinder W/C(RR) as well as front-left wheel cylinder W/C(FL) during the manual brake mode. When building up rear-right wheel-cylinder pressure Prr as well as front-left wheel-cylinder pressure Pfl by leg-power by the driver's foot, there is a problem of unnatural feeling that the driver experiences an excessive leg-power load. This is not realistic. For this reason, for the first hydraulic unit HU1 during the manual brake mode, the brake system of the shown embodiment is configured to apply master-cylinder pressure Pm to only the front-left road wheel FL, which generates a relatively great braking force in comparison with rear-right road wheel RR. Therefore, rear-right outflow valve OUT/V(RR) is constructed as a normally-open valve, for rapidly exhausting the residual pressure in rear-right wheel cylinder W/C(RR) into reservoir RSV and for avoiding undesirable rear-right wheel lock-up.

Referring now to FIG. 3, there is shown the hydraulic circuit diagram of 2^{nd} hydraulic unit HU2. Components incorporated in 2^{nd} hydraulic unit HU2 are electromagnetic valves, pump P2, and motor M2. The electromagnetic valves are constructed by a shutoff valve S.OFF/V, a front-right inflow valve IN/V(FR), a rear-left inflow valve IN/V(RL), a front-right outflow valve OUT/V(FR), and a rear-left outflow valve OUT/V(RL). The valve openings of these valves S.OFF/V, IN/V(FR), IN/V(RL), OUT/V(FR), and OUT/V(RL) are preset such that the ratio of a fluid pressure for front wheels FL, FR to a fluid pressure for rear wheels RL, RR is 2:1. The hydraulic circuit configurations and control operations are the same in both 1^{st} and 2^{nd} hydraulic units HU1-HU2. In explaining 2^{nd} hydraulic unit HU2, for the purpose of simplification of the disclosure, detailed description of the similar components will be omitted because the above description thereon seems to be self-explanatory. In a similar manner to 1^{st} hydraulic unit HU1, regarding 2^{nd} hydraulic unit HU2, front-right outflow valve OUT/V(FR) is comprised of a normally-closed proportional control valve, whereas rear-left outflow valve OUT/V(RL) is comprised of a normally-open proportional control valve. For the second hydraulic unit HU2 during the manual brake mode, the brake system of the shown embodiment is configured to apply master-cylinder pressure Pm to only the front-right road wheel FR, which generates a relatively great braking force in comparison with rear-left road wheel RL. As previously noted, rear-left outflow valve OUT/V(RL) is constructed as a normally-open valve, for rapidly exhausting the residual pressure in rear-left wheel cylinder W/C(RL) into reservoir RSV and for avoiding undesirable rear-left wheel lock-up.

[Brake-By-Wire Control Processing]

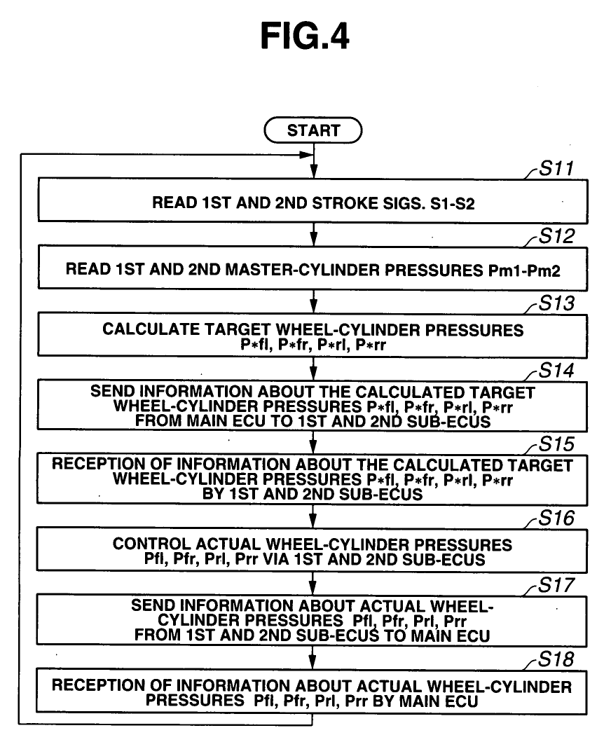

Referring now to FIG. 4, there is shown the brake-by-wire (BBW) control routine executed within main ECU 300, and 1^{st} and 2^{nd} sub-ECUs 100-200. The BBW control processing shown in FIG. 4 is executed as time-triggered interrupt routines to be triggered every predetermined time intervals.

At step S11, 1^{st} and 2^{nd} stroke signals S1-S2 are read, and then the routine proceeds to step S12.

At step S12, 1^{st} and 2^{nd} master-cylinder pressures Pm1-Pm2 are read, and then the routine proceeds to step S13.

At step S13, within 1^{st} and 2^{nd} CPUs 310-320 of main ECU 300, target wheel-cylinder pressures P*fl, P*fr, P*rl, and P*rr for 1^{st} and 2^{nd} hydraulic units HU1-HU2 are calculated based on stroke signals S1-S2 and master-cylinder pressures Pm1-Pm2, and then the routine proceeds to step S14.

At step S14, informational data about the calculated target wheel-cylinder pressures P*fl to P*rr are sent from main ECU 300 to 1^{st} and 2^{nd} sub-ECUs 100-200, and then the routine proceeds to step S15.

At step S15, 1^{st} and 2^{nd} sub-ECUs 100-200 receive the informational data about the calculated target wheel-cylinder pressures P*fl to P*rr, and then the routine proceeds to step S16.

At step S16, 1^{st} and 2^{nd} sub-ECUs 100-200 drive respective hydraulic units HU1-HU2, to control or regulate actual wheel-cylinder pressures Pfl to Prr, and then the routine proceeds to step S17.

At step S17, 1^{st} and 2^{nd} sub-ECUs 100-200 send informational data about actual wheel-cylinder pressures Pfl to Prr to main ECU 300, and then the routine proceeds to step S18.

At step S18, main ECU 300 receives the informational data about actual wheel-cylinder pressures Pfl to Prr. Thereafter, the routine returns to step S11.

[Stroke-Simulator Cutoff Valve Opening/Closing Control]

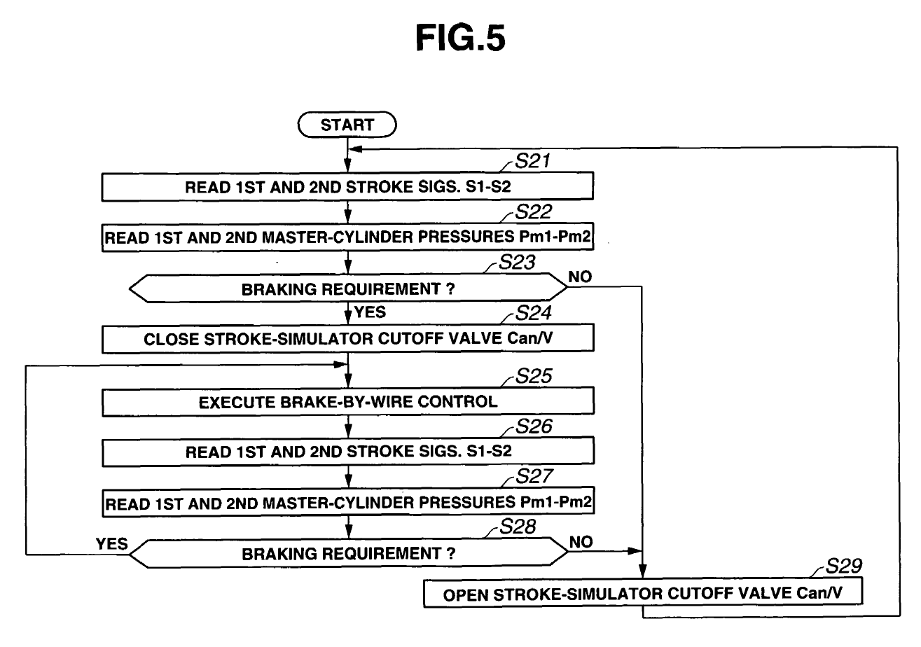

Referring now to FIG. 5, there is shown the stroke-simulator cutoff valve Can/V opening/closing control routine, executed within main ECU 300. The stroke-simulator cutoff valve opening/closing control routine of FIG. 5 is also executed as time-triggered interrupt routines to be triggered every predetermined time intervals.

At step S21, 1^{st} and 2^{nd} stroke signals S1-S2 are read, and then the routine proceeds to step S22.

At step S22, 1^{st} and 2^{nd} master-cylinder pressures Pm1-Pm2 are read, and then the routine proceeds to step S23.

At step S23, a check is made to determine, based on input information regarding 1^{st} and 2^{nd} stroke signals S1-S2 and 1^{st} and 2^{nd} master-cylinder pressures Pm1-Pm2, whether a driver's braking requirement is present or absent. When the answer to step S23 is in the affirmative (YES), that is, in the presence of the driver's braking requirement, the routine proceeds from step S23 to step S24. Conversely when the answer to step S23 is in the negative (NO), that is, in the absence of the driver's braking requirement, the routine proceeds from step S23 to step S29.

At step S24, stroke-simulator cutoff valve Can/V is switched to its closed state, and then the routine proceeds to step S25.

At step S25, the brake-by-wire control of FIG. 4 is executed, and then the routine proceeds to step S26.

At step S26, 1^{st} and 2^{nd} stroke signals S1-S2 are read, and then the routine proceeds to step S27.

At step S27, 1^{st} and 2^{nd} master-cylinder pressures Pm1-Pm2 are read, and then the routine proceeds to step S28.

At step S28, a check is made to determine, based on input information regarding 1^{st} and 2^{nd} stroke signals S1-S2 and 1^{st} and 2nd master-cylinder pressures Pm1-Pm2, whether a driver's braking requirement is present or absent. When the answer to step S28 is affirmative (YES), that is, in the presence of the driver's braking requirement, the routine proceeds from step S28 to step S25. Conversely when the answer to step S28 is negative (NO), that is, in the absence of the driver's braking requirement, the routine proceeds from step S28 to step S29.

At step S29, stroke-simulator cutoff valve Can/V is switched to its open state, and then the routine returns to step S21.

[Pump Backflow Prevention Control]

As can be seen from the circuit diagrams of FIGS. 2-3, the brake control apparatus of the embodiment is configured to build up wheel-brake cylinders W/C(FL) to W/C(RR) by pumps P1-P2 only during the pressure buildup mode. When pressure buildup-to-reduction mode switching occurs, pumps P1-P2 are both stopped and working fluid in wheel-brake cylinders W/C(FL) to W/C(RR) can be exhausted through respective outflow valves OUT/V(FL) to OUT/V(RR) to reservoir RSV.

Even when pumps P1-P2 have been shifted to their stopped states during mode-switching from pressure-buildup to pressure-reduction or during mode-switching from pressure-buildup to pressure-hold, pump speeds Np of pumps P1-P2 do not drop to zero speed at once, but pumps P1-P2 continue to rotate for a while owing to rotational inertia.

Additionally, owing to fluid mass inertia of working-fluid mass flow from suction line H1 to discharge line F1 and owing to fluid mass inertia of working-fluid mass flow from suction line H2 to discharge line F2, working-fluid supply into these discharge lines F1-F2 of pumps P1-P2 continues for a while. Thus, the buildup of working-fluid pressure in each of discharge lines F1-F2 is continued until each of pump speeds Np of pumps P1-P2 has dropped to zero speed.

As used hereafter, discharge lines F1-F2 are collectively referred to as “discharge line F”, suction lines H1-H2 are collectively referred to as “suction line H”, fluid lines B1-B2 are collectively referred to as “fluid line B”, and fluid lines E1-E2 are collectively referred to as “fluid line E”. Assuming that, as soon as pump speeds Np of pumps P1-P2 have dropped to zero, the fluid pressure in discharge line F becomes completely reduced and thus there is no pressure difference between discharge line F and suction line H, reverse rotation of each of pumps P1-P2 does not occur. Actually, fluid lines B and E, all of which serve as pressure reduction circuits, have flow resistances that impede working-fluid flow. Necessarily, there is a delay in reducing operation of working-fluid pressure, owing to these flow resistances.

Accordingly, even when pumps P1-P2 have been shifted to their stopped states due to mode-switching operation, a residual pressure tends to stay in discharge line F. Owing to the pressure difference between discharge line F of a relatively high hydraulic pressure and suction line H of a relatively low hydraulic pressure, reverse rotation of each of pumps P1-P2 occurs, and thus working fluid flows from discharge line F back to suction line H. There is no problem, if such pump backflow stops at a point of time when the fluid pressure in discharge line F becomes identical to that in suction line H. Actually, owing to the rotational inertia of each of pumps P1-P2 (exactly, the rotational inertia of each of pump motors M1-M2 rotating in their reverse-rotational directions) and owing to the fluid mass inertia of working-fluid mass flow from discharge line F to suction line H, reverse rotation of each of pumps P1-P2 continues for a while. That is to say, pump backflow never stops soon, even when the fluid pressure in discharge line F becomes identical to that in suction line H. As a result, owing to the backflow continuing for a while after the fluid pressure in discharge line F has become identical to that in suction line H, the fluid pressure in suction line H tends to become higher than the fluid pressure in discharge line F. Suction line H is connected to reservoir RSV and thus the fluid pressure in suction line H becomes atmospheric pressure. Therefore, the fluid pressure in discharge line F becomes negative (less than atmospheric). When restarting the buildup of discharge pressure of the pump, first, the fluid pressure in discharge line F must be risen from a negative pressure up to a positive pressure, and then the positive pressure in discharge line F must be further risen up to a target fluid pressure. That is, a surplus pressure buildup operation covering the negative pressure must be made, thus resulting in a discharge response delay.

As previously described, one way to avoid the undesirable working-fluid backflow from the pump discharge side to the pump suction side (simply, “pump backflow”) is to continuously apply electricity to the pump motor in such a manner as to rotate the pump in its normal-rotational direction, even during a mode transition from pressure-buildup to pressure-reduction. However, in such a case, electricity (electric current) has to be wastefully applied to the pump motor, even when the working-fluid pressure in discharge line F is positive and thus there is no risk of pump backflow, thereby increasing electricity consumption.

In contrast to the above, according to the brake control apparatus of the embodiment, a rotational direction of each of pumps P1-P2 is detected. Only when reverse rotation of the pump has been detected, a driving command is outputted to the pump motor rotating in the reverse-rotational direction, in order to change the rotational direction of the pump motor, rotating reversely, to the normal-rotational direction. This contributes to the improved pump discharge response, while preventing or suppressing electric current from being unnecessarily applied to the pump motor during the pressure reduction mode.

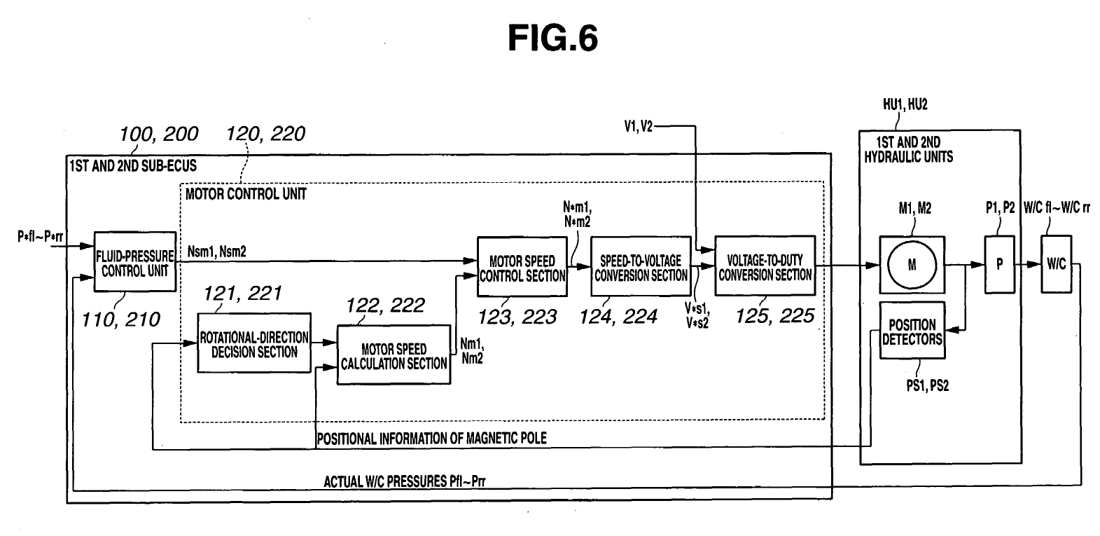

Referring now to FIG. 6, there is shown the motor control block diagram of motor control executed within 1^{st} and 2^{nd} sub-ECUs 100-200. As seen from the block diagram of FIG. 6, the unit configurations and components are the same in 1^{st} and 2^{nd} sub-ECUs 100-200, and thus the detailed construction for only the 1^{st} sub-ECU 100 is hereinafter explained in reference to the block diagram of FIG. 6, while detailed description of the similar components of 2^{nd} sub-ECU 200 will be omitted.

1^{st} sub-ECU 100 of FIG. 6 includes a fluid-pressure control unit 110 and a motor control unit 120. Motor control unit 120 is comprised of a rotational-direction decision section 121, a motor speed calculation section 122, a motor speed control section 123, a speed-to-voltage conversion section 124, and a voltage-to-duty conversion section 125.

Fluid-pressure control unit 110 calculates, based on target wheel-cylinder pressures P*fl to P*rr inputted from main ECU 300, a motor speed command Nsm1 of 1^{st} motor M1, and then generates the calculated motor speed command Nsm1 to motor speed control section 123 of motor control unit 120.

Rotational-direction decision section 121 of motor control unit 120 determines or discriminates the rotational direction of motor M1 (in other words, a rotational direction of pump P1) based on positional information of magnetic pole from a position detector PS1 installed on motor M1, and then generates the decision result to motor speed calculation section 122. In a similar manner, a position detector PS2 is located on motor M2, for detecting positional information of magnetic pole of motor M2. In the shown embodiment, each of position detectors PS1-PS2 is constructed by a position sensor, such as a potentiometer, that detects the positional information of magnetic pole of the pump motor. It is possible to determine the rotational direction of the pump motor based on the detected pattern of positional information of magnetic pole. Motor speed calculation section 122 calculates an actual motor speed Nm1 of 1^{st} motor M1, based on the positional information of magnetic pole and the motor rotation direction, and then generates the calculated actual motor speed Nm1 to motor speed control section 123.

Motor speed control section 123 calculates an output voltage equivalent value N*m1 of 1^{st} motor M1, based on both motor speed command Nsm1 and actual motor speed Nm1, and then generates the calculated output voltage equivalent value N*m1 to speed-to-voltage conversion section 124.

Speed-to-voltage conversion section 124 converts the inputted 1^{st} motor output voltage equivalent value N*m1 to a target voltage command V*s1, and then generates the converted target voltage command V*s1 to voltage-to-duty conversion section 125.

Voltage-to-duty conversion section 125 operates to duty-convert or pulse-width-modulate, based on target voltage command V*s1, an input voltage V1, and then generates the duty-converted pulse signal to 1^{st} motor M1.

[Pump Backflow Prevention Control Processing Based on Motor Speed Control]

(Main Flow)

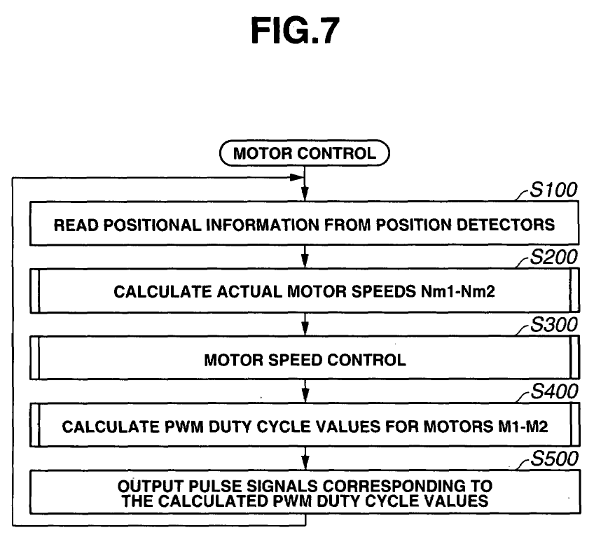

Referring now to FIG. 7, there is shown the main flow chart concerning pump backflow prevention control processing (pump reverse-rotation suppression control processing) based on motor speed control.

At step S100, positional information of magnetic pole, generated from each of position detectors PS1-PS2, is read, and then the routine proceeds to step S200.

At step S200, actual motor speeds Nm1-Nm2 of 1^{st} and 2^{nd} motors M1-M2 are calculated based on the positional information from position detectors PS1-PS2, and then the routine proceeds to step S300.

At step S300, motor speed control for each of 1^{st} and 2^{nd} motors M1-M2 is executed, and output voltage equivalent values N*m1-N*m2 are calculated. Then, the routine proceeds to step S400.

At step S400, pulse-width modulated (PWM) duty cycle values for 1^{st} and 2^{nd} motors M1-M2, corresponding to the respective output voltage equivalent values N*m1-N*m2, are calculated by way of voltage-to-duty conversion (pulse-duration modulation). Thereafter, the routine proceeds to step S500.

At step S500, pulse signals corresponding to the calculated PWM duty cycle values for 1^{st} and 2^{nd} motors M1-M2 are outputted. In this manner, one execution cycle of pump backflow prevention control processing (pump reverse-rotation suppression control processing) based on motor speed control terminates.

(Motor Speed Calculation Flow)

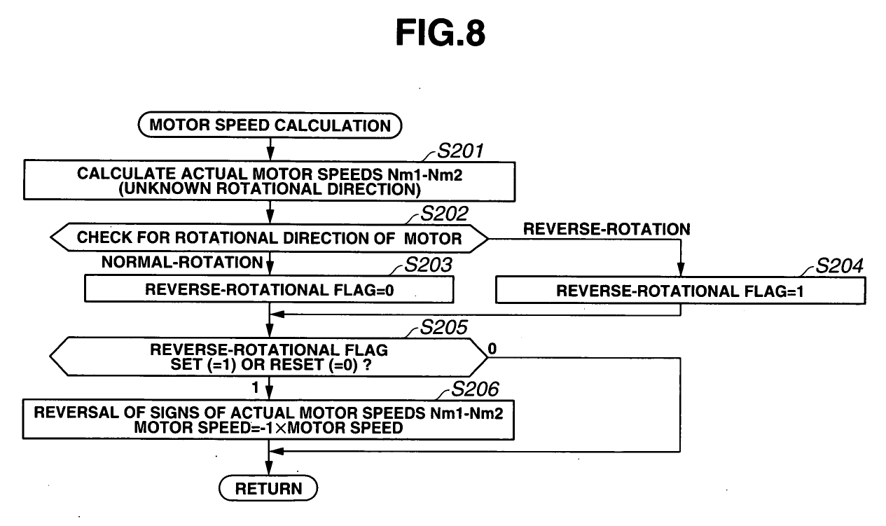

Referring now to FIG. 8, there is shown the motor speed calculation routine related to step S200 of FIG. 7. The motor speed arithmetic processing is executed within motor speed calculation sections 122-222. As used hereafter, 1^{st} and 2^{nd} motors M1-M2 are collectively referred to as “motor M”.

At step S201, actual motor speeds Nm1-Nm2 are calculated and then the routine proceeds to step S202. At the point of time of arithmetic processing of step S201, the sign of each of actual motor speeds Nm1-Nm2 is unknown, and thus it is not yet determined that the rotational direction of motor M is a normal-rotational direction or a reverse-rotational direction.

At step S202, a check is made to determine whether the rotational direction of motor M is a normal-rotational direction or a reverse-rotational direction. When step S202 determines that motor M rotates in the normal-rotational direction, the routine proceeds step S203. Conversely when step S202 determines that motor M rotates in the reverse-rotational direction, the routine proceeds step S204.

At step S203, a reverse-rotational flag is reset to “0”, and then the routine proceeds to step S205.

At step S204, the reverse-rotational flag is set to “1”, and then the routine proceeds to step S205.

At step S205, a check is made to determine whether the reverse-rotational flag is set (=1) or reset (=0). When the reverse-rotational flag is reset (=0), one execution cycle of the motor speed calculation routine terminates. Conversely when the reverse-rotational flag is set (=1), the routine proceeds to step S206.

At step S206, the signs of actual motor speeds Nm1-Nm2 are reversed, and then motor speed indicative signals of the reversed signs are outputted. In this manner, one execution cycle terminates.

(Motor Speed Control Flow)

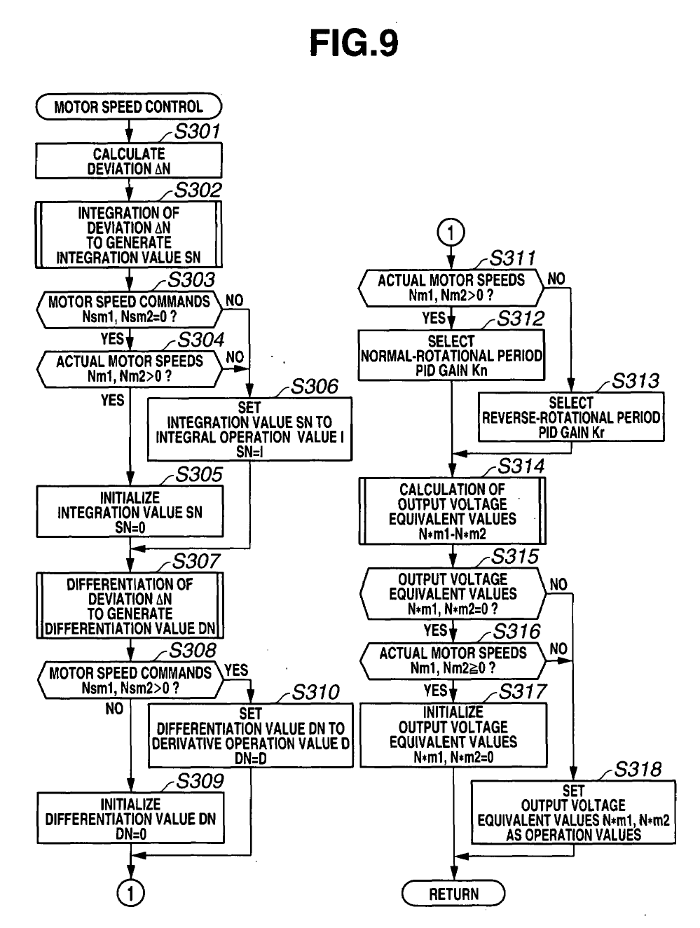

Referring now to FIG. 9, there is shown the motor speed control routine related to step S300 of FIG. 7. The motor speed control processing is executed within motor speed control sections 123-223.

At step S301, a deviation ΔN (a speed difference) between 1^{st} motor speed command Nsm1 and actual motor speed Nm1 and a deviation ΔN between 2^{nd} motor speed command Nsm2 and actual motor speed Nm2 are calculated, and then the routine proceeds to step S302.

At step S302, the calculated deviation ΔN is integrated to generate an integration value SN of deviation ΔN, and then the routine proceeds to step S303.

At step S303, a check is made to determine whether each of 1^{st} and 2^{nd} motor speed commands Nsm1-Nsm2 is “0”. When the answer to step S303 is affirmative (Nsm1, Nsm2=0), the routine proceeds to step S304. Conversely when the answer to step S303 is negative (Nsm1, Nsm2≠0), the routine proceeds to step S306.

At step S304, a check is made to determine whether each of 1^{st} and 2^{nd} actual motor speeds Nm1-Nm2 is positive (>0). When the answer to step S304 is affirmative (Nm1, Nm2>0), the routine proceeds to step S305. Conversely when the answer to step S304 is negative (Nm1, Nm2≦0), the routine proceeds to step S306.

At step S305, integration value SN of deviation ΔN is initialized to “0”, and then the routine proceeds to step S307.

At step S306, integration value SN of deviation ΔN is set as an integral operation value I, and then the routine proceeds to step S307.

At step S307, the calculated deviation ΔN is differentiated to generate a differentiation value DN of deviation ΔN, and then the routine proceeds to step S308.

At step S308, a check is made to determine whether each of 1^{st} and 2^{nd} motor speed commands Nsm1-Nsm2 is positive (>0). When the answer to step S308 is affirmative (Nsm1, Nsm2>0), the routine proceeds to step S310. Conversely when the answer to step S308 is negative (Nsm1, Nsm2≦0), the routine proceeds to step S309.

At step S309, differentiation value DN of deviation ΔN is initialized to “0”, and then the routine proceeds to step S311.

At step S310, differentiation value DN of deviation ΔN is set as a derivative operation value D, and then the routine proceeds to step S311.

At step S311, a check is made to determine whether each of 1^{st} and 2^{nd} actual motor speeds Nm1-Nm2 is positive (>0). When the answer to step S311 is affirmative (Nm1, Nm2>0), the routine proceeds to step S312. Conversely when the answer to step S311 is negative (Nm1, Nm2<0), the routine proceeds to step S313.

At step S312, of a proportional-plus-integral-plus-derivative (PID) control gain (a normal PID control gain) Kn during normal rotation of motor M and a proportional-plus-integral-plus-derivative (PID) control gain Kr during reverse rotation of motor M, the normal-rotational period PID gain Kn is selected, and then the routine proceeds to step S314.

In contrast, at step S313, the reverse-rotational period PID gain Kr is selected, and then the routine proceeds to step S314.

At step S314, output voltage equivalent values N*m1-N*m2 are calculated based on deviation AN (an error signal), integral operation value I (the integral of the error signal), derivative operation value D (the derivative of the error signal), and the selected PID gain (either Kn or Kr), and then the routine proceeds to step S315.

At step S315, a check is made to determine whether each of output voltage equivalent values N*m1-N*m2 is “0”. When the answer to step S315 is affirmative (N*m1, N*m2=0), the routine proceeds to step S316. Conversely when the answer to step S315 is negative (N*m1, N*m2#0), the routine proceeds to step S318.

At step S316, a check is made to determine whether each of 1^{st} and 2^{nd} actual motor speeds Ns1-Ns2 is greater than or equal to zero (≧0). When the answer to step S316 is affirmative (Nm1, Nm2>0), the routine proceeds to step S317. Conversely when the answer to step S316 is negative (Nm1, Nm2<0), the routine proceeds to step S318.

At step S317, output voltage equivalent values N*m1-N*m2 are initialized to “0”.

At step S318, output voltage equivalent values N*m1-N*m2 are retained unchanged and then outputted as operation values. After steps S317 or S318, one execution cycle of motor speed control terminates.

[Comparison of Time Charts Obtained Without Pump Backflow Prevention Control and With Pump Backflow Prevention Control]

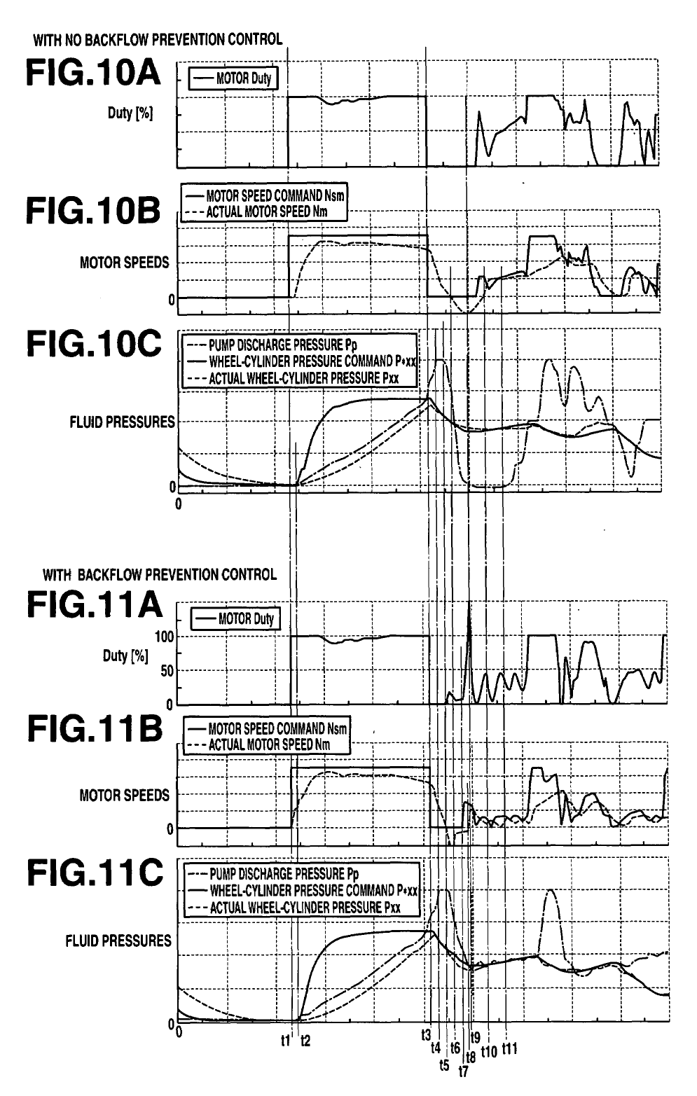

As used hereafter, 1^{st} and 2^{nd} motor speed commands Nsm1-Nsm2 are collectively referred to as “motor speed command Nsm”, 1^{st} and 2^{nd} actual motor speeds Nm1-Nm2 are collectively referred to as “actual motor speed Nm”, 1^{st} and 2^{nd} pump discharge pressures Pp1-Pp2 are collectively referred to as “pump discharge pressure Pp”, target wheel-cylinder pressures (wheel-cylinder pressure commands) P*fl, P*fr, P*rl, and P*rr are collectively referred to as “target wheel-cylinder pressure P*xx”, actual wheel-cylinder pressures Pfl, Pfr, Prl, and Prr are collectively referred to as “actual wheel-cylinder pressure Pxx”, wheel-brake cylinders W/C(FL), W/C(FR), W/C(RL), W/C(RR) are collectively referred to as “wheel-brake cylinder W/C”, and position detectors PS1-PS2 are collectively referred to as “position detector PS”. FIGS. 10A-10C show a variation in the motor-drive duty cycle value for a driving signal for driving the pump motor M, variations in motor speeds (motor speed command Nsm and actual motor speed Nm), and variations in several fluid pressures (discharge pressure Pp, target wheel-cylinder pressure P*xx, and actual wheel-cylinder pressure Pxx) with no execution of pump backflow prevention control (PBPC). On the other hand, FIGS. 11A-11C show a variation in the motor-drive duty cycle value for a driving signal for driving the pump motor M, variations in motor speeds (motor speed command Nsm and actual motor speed Nm), and variations in several fluid pressures (discharge pressure Pp, target wheel-cylinder pressure P*xx, and actual wheel-cylinder pressure Pxx) with execution of pump backflow prevention control (PBPC).

(Time t1)

At the time t1, a pressure buildup command is generated, and thus the motor-drive duty cycle value of the duty cycle modulated pulse-width signal becomes 100% (see FIGS. 10A and (11A).

(Time t2)

At the time t2, the actual wheel-cylinder pressure Pxx begins to build up (see the characteristic curves indicated by the broken line in each of FIGS. 10C and 11C).

(Time t3)

At the time t3 when switching from the pressure buildup mode to the pressure reduction mode, the motor-drive duty cycle value becomes dropped to 0% (see FIGS. 10A and 11A), and thus actual motor speed Nm begins to decrease. On the other hand, discharge pressure Pp and actual wheel-cylinder pressure Pxx tend to further rise with a time delay from the time t3, owing to the rotational inertia of each of pumps P1-P2 and owing to the fluid mass inertia of working-fluid mass flow from suction line H to discharge line F.

(Time t4)

At the time t4, discharge pressure Pp reaches a peak (a maximum discharge pressure level).

(Time t5)

At the time t5, discharge pressure Pp begins to fall. At the same time, backflow of working fluid from the pump discharge side to the pump suction side occurs and thus pumps P1-P2 begin to rotate in their reverse-rotational directions. As a result, as can be seen from the actual motor speed characteristic indicated by the broken line in FIG. 11B, actual motor speed Nm becomes negative from the time t5. Therefore, the apparatus of the embodiment initiates pump backflow prevention control (PBPC) from the time t5 by generating a command signal responsively to which motor M is driven in the normal-rotational direction. Actually, the motor-drive duty cycle value begins to increase from 0% from the time t5 (see FIG. 11A).

(Time t6)

In the case of the non-PBPC-system equipped brake apparatus shown in FIGS. 10A-10C, as can be seen from the actual motor speed characteristic indicated by the broken line in FIG. 10B, actual motor speed Nm becomes negative from the time t6. The non-PBPC-system equipped brake apparatus of FIGS. 10A-10C never executes pump backflow prevention control, and thus the motor-drive duty cycle value remains kept at 0%.

(Time t7)

At the time t7, in the PBPC-system equipped brake apparatus of FIGS. 11A-11C motor speed command Nsm becomes positive, whereas in the non-PBPC-system equipped brake apparatus of FIGS. 10A-10C motor speed command Nsm remains kept at zero.

(Time t8)

At the time t8, in the PBPC-system equipped brake apparatus of FIGS. 11A-11C actual motor speed Nm of motor M becomes positive (see the actual motor speed characteristic indicated by the broken line in FIG. 11B), and as a result the wheel-cylinder pressures begin to increase from the time t8. In the case of the PBPC-system equipped brake apparatus of FIGS. 11A-11C, executing the pump backflow prevention control at once at the time t5, discharge pressure Pp can be always maintained at the positive pressure level. Therefore, the PBPC-system equipped brake apparatus of FIGS. 11A-11C enables a rapid mode transition to the pressure buildup mode, as soon as motor M begins to rotate in the normal-rotational direction.

(Time t9)

At the time t9, in the non-PBPC-system equipped brake apparatus of FIGS. 10A-10C, discharge pressure Pp becomes negative.

(Time t10)

At the time t10, in the non-PBPC-system equipped brake apparatus of FIGS. 10A-10C, actual motor speed Nm of motor M becomes positive, but discharge pressure Pp remains negative.

(Time t11)

At the time t11, in the non-PBPC-system equipped brake apparatus of FIGS. 10A-10C, discharge pressure Pp becomes positive, and then the buildup of working-fluid pressure in wheel-brake cylinder W/C starts. In the case of the non-PBPC-system equipped brake apparatus of FIGS. 10A-10C, actual wheel-cylinder pressure Pxx becomes negative at the point of time when motor M begins to rotate in the normal-rotational direction. Thus, a real mode transition to the pressure buildup mode cannot occur, until the fluid pressure in discharge line F has been changed from negative to positive. As compared to the PBPC-system equipped brake apparatus of FIGS. 11A-11C, there is a discharge response delay in the case of the non-PBPC-system equipped brake apparatus of FIGS. 10A-10C.

### Effects of the Embodiment

(1) In the brake control apparatus of the embodiment, including master cylinder M/C, wheel-brake cylinders W/C(FL) to W/C(RR) provided at respective road wheels FL to RR, 1^{st} and 2^{nd} hydraulic units HU1-HU2 provided independently of master cylinder M/C for controlling or regulating wheel-cylinder pressures Pfl to Prr, 1^{st} and 2^{nd} sub-ECUs 100-200 that control the respective hydraulic units HU1-HU2, and pumps P1-P2 incorporated in the respective hydraulic units HU1-HU2, the brake control apparatus of the embodiment has a pump backflow prevention control system (a pump reverse-rotation suppression control system) that can execute pump backflow prevention control (pump reverse-rotation suppression control). Thus, by virtue of the pump backflow prevention control (pump reverse-rotation suppression control), it is possible to improve a pump discharge response while effectively reducing or suppressing electric current from being unnecessarily applied to the pump motor M during a pressure reduction mode.

(2) Sub-ECUs 100-200 are configured to detect respective rotational directions of pumps P1-P2 (or pump motors M1-M2). Only when reverse rotation of the pump (the pump motor) has been detected, sub-ECUs 100-200 generate driving command signals to respective motors M1-M2, in order to rotate pumps P1-P2 in their normal-rotational directions. There is no occurrence of backflow of working fluid from the pump discharge side to the pump suction side during normal rotation of pumps P1-P2, and thus it is possible to temporarily stop motors M1-M2 during the normal rotation of pumps P1-P2. Additionally, it is possible to effectively reduce electric power consumption by driving motors M1-M2 only when reverse rotation of the pump has been detected. By rotating pumps P1-P2 in their normal-rotational directions upon detection of reverse rotation of the pump, it is possible to avoid the fluid pressure in discharge line F from becoming negative, thereby preventing cavitation from occurring, and consequently enhancing the durability of each of hydraulic units HU1-HU2.

(3) When the sub-ECU (100, 200) detects reverse rotation of the associated pump (P1, P2), the sub-ECU is configured to switch the control gain of the associated motor (M1, M2) from normal-rotational period PID gain Kn to reverse-rotational period PID gain Kr. Thus, it is possible to easily prevent backflow only by way of the Kn-to-Kr PID gain switching.

Additionally, the information on whether the pump is rotating in a normal-rotational direction or in a reverse-rotational direction is precisely detected by means of the position detector (PS1, PS2), constructed by a position sensor, such as a potentiometer, which is installed on the associated motor (M1, M2) for detecting the positional information of the motor magnetic pole. By directly detecting rotation of the motor, it is possible to easily precisely determine whether the motor begins to rotate in the reverse-rotational direction.

Furthermore, in the shown embodiment, each of motors M1-M2 is comprised of a brushless motor, and the position detector (PS1, PS2) is installed on the associated brushless motor to detect the angular position of the brushless-motor rotor, which is fixedly connected to a pump shaft (a driven shaft) of pump (P1, P2). As is generally known, a position sensor is indispensable to such a brushless motor. By detecting the normal-rotational state or reverse-rotational state of the motor by the use of the position sensor indispensable to the brushless motor, it is possible to easily precisely detect the rotational direction of motor M without adding a new positional-information sensor.

In the shown embodiment, hydraulic actuators are constructed by 1^{st} and 2^{nd} hydraulic units HU1-HU2 having respective fluid-pressure sources, namely, the 1^{st} fluid-pressure source (1^{st} pump P1) and the 2^{nd} fluid-pressure source (2^{nd} pump P2). 1^{st} hydraulic unit HU1 is configured to control or regulate front-left and rear-right wheel-brake cylinder pressures Pfl and Prr by 1^{st} fluid-pressure source (pump P1), while 2^{nd} hydraulic unit HU2 is configured to control or regulate front-right and rear-left wheel-brake cylinder pressures Pfr and Prl by 2^{nd} fluid-pressure source (pump P2). Thus, it is possible to easily provide or realize a brake-by-wire system equipped vehicle by applying the brake control apparatus of the embodiment to an automotive vehicle employing a general diagonal split layout (X-split layout) of brake circuits.

As previously discussed, the 1^{st} fluid-pressure source is comprised of 1^{st} pump P1, whereas the 2^{nd} fluid-pressure source is comprised of 2^{nd} pump P2. The fluid pressures in wheel-brake cylinders W/C(FL) to W/C(RR) can be built up directly by means of these pumps P1-P2. It is possible to build up wheel-cylinder pressures Pfl to Prr without using any pressure accumulators, and thus there is no risk of undesirable blending (leakage) of gas in the accumulator into working fluid in the fluid lines in the presence of a brake system failure. Such an accumulatorless hydraulic brake system contributes to smaller space requirements of overall system.

Moreover, in the shown embodiment, 1^{st} and 2^{nd} hydraulic units HU1-HU2 are configured as separate units. Therefore, even if an oil leakage occurs in either one of 1^{st} and 2^{nd} hydraulic units HU1-HU2, it is possible to produce or secure a braking force by means of the other unfailed hydraulic unit that an oil leakage does not occur.

1^{st} and 2^{nd} hydraulic units HU1-HU2 are configured as separate units, but it is preferable that these hydraulic units HU1-HU2 are integrally connected to each other. In the case of integral construction of hydraulic units HU1-HU2, electric circuit configurations can be gathered to one place, thus realizing shortened harness lengths and simplified brake system layout.

Electric power is supplied from 1^{st} electric power source BATT1 to 1^{st} hydraulic unit HU1, whereas electric power is supplied from 2^{nd} electric power source BATT2 to 2^{nd} hydraulic unit HU2. Thus, even if either 1^{st} electric power source BATT1 or 2^{nd} electric power source BATT2 is failed, either one of hydraulic units HU1-HU2 can be driven or operated by means of the unfailed electric power source, thus securing a braking force.

[Modified Motor Control System]

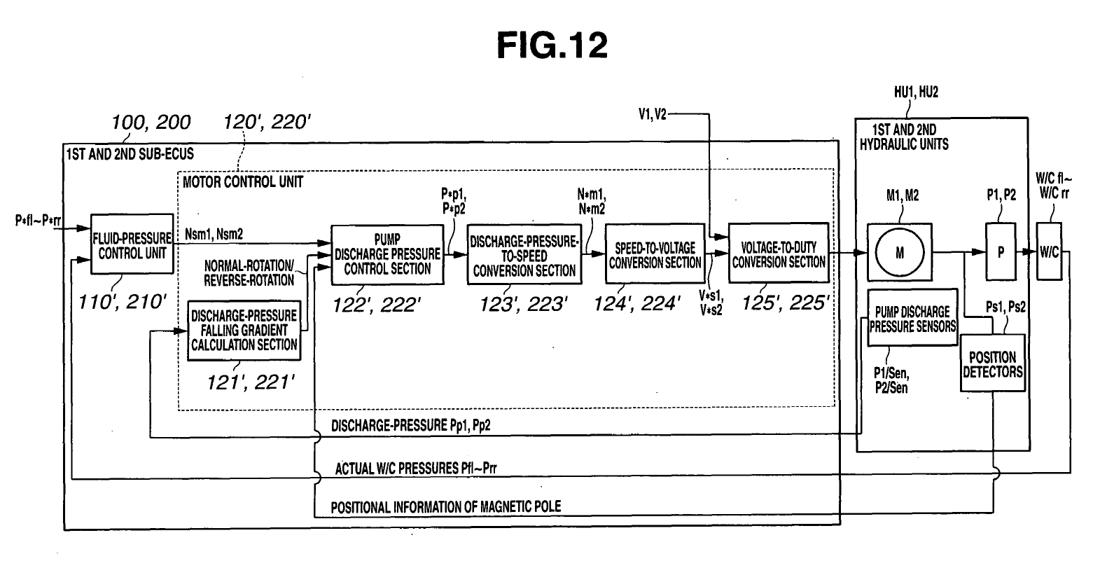

Referring now to FIG. 12, there is shown the motor control block diagram of the modified motor control system. The basic construction of the modified motor control system of FIG. 12 is similar to that of the motor control system of FIG. 6 incorporated in the brake control apparatus of the embodiment, and thus only a different point is hereinafter explained.

In the motor control system of the embodiment shown in FIG. 6, in order to detect or determine the state of reverse rotation of the pump (P1, P2), the rotational direction of motor M, discriminated based on the positional information of magnetic pole from position detector PS, is utilized.

On the other hand, in the modified motor control system of FIG. 12, a falling gradient ΔPp1 of 1^{st} pump discharge pressure Pp1 (in other words, a time rate of decrease dPp1/dt in 1^{st} pump discharge pressure Pp1) and a falling gradient ΔPp2 of 2^{nd} pump discharge pressure Pp2 (in other words, a time rate of decrease dPp2/dt in 2^{nd} pump discharge pressure Pp2) are arithmetically calculated and utilized to estimate the reverse-rotational state of the pump. As used hereafter, 1^{st} pump discharge-pressure falling gradient ΔPp1 and 2^{nd} pump discharge-pressure falling gradient ΔPp2 are collectively referred to as “discharge-pressure falling gradient ΔPp”. The reverse-rotational state of the pump (P1, P2) is estimated based on the comparison result of the discharge-pressure falling gradient ΔPp and its predetermined threshold value Pα. Concretely, when discharge-pressure falling gradient ΔPp becomes greater than or equal to predetermined threshold value Pα (i.e., ΔPp≧Pα), it is estimated or determined that reverse rotation of the pump occurs. Note that, in the modified motor control system of FIG. 12, the comparing action of discharge-pressure falling gradient ΔPp and predetermined threshold value Pα is executed under a state where a fluid-pressure supply from the pump to each individual wheel-brake cylinder is stopped, for example, during the pressure reduction mode or during the pressure hold mode. That is, the modified motor control system of FIG. 12 is different from the motor control system of FIG. 6, in that in the modified system of FIG. 12 reverse rotation of the pump can be determined or estimated based on the comparison result of discharge-pressure falling gradient ΔPp and its threshold value Pα under the fluid-pressure supply stopped state, rather than the direct-detection method of the angular position of the pump-motor rotor.

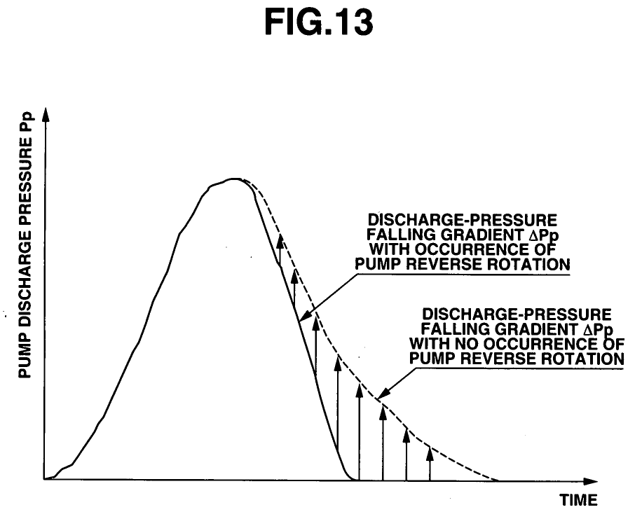

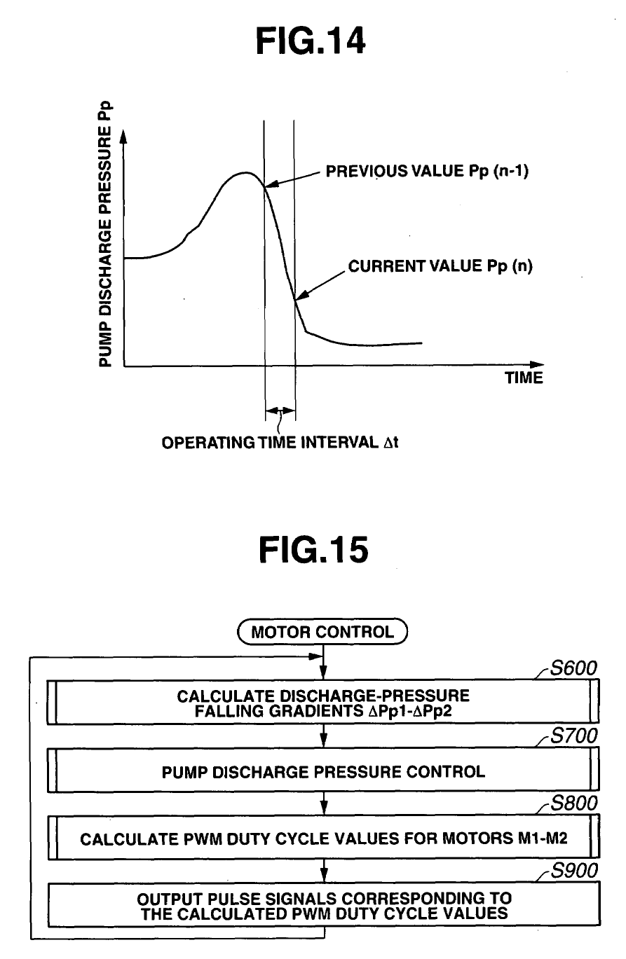

FIG. 13 shows a comparative example of a pump discharge pressure characteristic curve obtained with occurrence of pump reverse-rotation and a pump discharge pressure characteristic curve obtained with no occurrence of pump reverse-rotation. FIG. 14 shows an example of the pump discharge-pressure falling gradient ΔPp calculation map used within the modified motor control system shown in FIG. 12. As can be seen from the block diagram of FIG. 12, the unit configurations and components are the same in 1^{st} and 2^{nd} sub-ECUs 100-200, and thus the detailed construction for only the 1^{st} sub-ECU 100 is hereunder explained in reference to the block diagram of FIG. 12, while detailed description of the similar components of 2^{nd} sub-ECU 200 will be omitted.

1^{st} sub-ECU 100 of FIG. 12 includes a fluid-pressure control unit 110′ and a motor control unit 120′. Motor control unit 120′ is comprised of a discharge-pressure falling gradient calculation section 121′, a pump discharge pressure control section 122′, a discharge-pressure-to-speed conversion section 123′, a speed-to-voltage conversion section 124′, and a voltage-to-duty conversion section 125′.

Fluid-pressure control unit 110′ calculates, based on target wheel-cylinder pressures P*fl to P*rr inputted from main ECU 300, motor speed command Nsm1 of 1^{st} motor M1, and then generates the calculated motor speed command Nsm1 to pump discharge pressure control section 122′ of motor control unit 120′.

Discharge-pressure falling gradient calculation section 121′ arithmetically calculates discharge-pressure falling gradient ΔPp1 based on discharge pressure Pp1 detected by 1^{st} pump discharge pressure sensor P1/Sen. Thereafter, discharge-pressure falling gradient calculation section 121′ generates an informational signal regarding reverse-rotation/normal-rotation of pump P1. More concretely, when the calculated discharge-pressure falling gradient ΔPp1 is greater than or equal to threshold value Pα (i.e., ΔPp≧Pα), the reverse-rotational state of pump 1 is estimated or determined, and then discharge-pressure falling gradient calculation section 121′ generates a signal indicative of reverse rotation of pump P1. Conversely when the calculated discharge-pressure falling gradient ΔPp1 is less than threshold value Pα (i.e., ΔPp<Pα), the normal-rotational state of pump 1 is estimated or determined, and then discharge-pressure falling gradient calculation section 121′ generates a signal indicative of normal rotation of pump P1.

As seen in FIG. 14, discharge-pressure falling gradient ΔPp1 of 1^{st} pump P1 is arithmetically calculated by dividing the difference of the previous value Pp1(n−1) of discharge pressure Pp1 and the current value Pp1(n) of discharge pressure Pp1 with the predetermined execution cycle (operating time interval Δt), as follows.

ΔPp1={Pp1(n−1)−Pp1(n)}/Δt

Pump discharge pressure control section 122′ calculates a target discharge pressure P*p1 of pump P1, based on the positional information of magnetic pole, motor speed command Nsm1, and the estimation result of reverse-rotation/normal-rotation of pump P1, and then generates the calculated target discharge pressure P*p1 to discharge-pressure-to-speed conversion section 123′.

Discharge-pressure-to-speed conversion section 123′ converts the inputted target discharge pressure P*p1 to output voltage equivalent value N*m1 of 1^{st} motor M1, and then generates the converted output voltage equivalent value N*m1 to speed-to-voltage conversion section 124′.

Speed-to-voltage conversion section 124′ converts the inputted 1^{st} motor output voltage equivalent value N*m1 to a target voltage command V*s1, and then generates the converted target voltage command V*s1 to voltage-to-duty conversion section 125′.

Voltage-to-duty conversion section 125′ operates to duty-convert or pulse-width-modulate, based on target voltage command V*s1, an input voltage V1, and then generates the duty-converted pulse signal to 1^{st} motor M1.

[Pump Backflow Prevention Control Processing Based on Discharge Pressure Control]

(Main Flow)

Referring now to FIG. 15, there is shown the main flow chart concerning pump backflow prevention control processing (pump reverse-rotation suppression control processing) based on discharge pressure control.

At step S600, discharge-pressure falling gradient ΔPp1 of 1^{st} pump P1 and discharge-pressure falling gradient ΔPp2 of 2^{nd} pump P2 are arithmetically calculated, and then the routine proceeds to step S700.

At step S700, discharge pressure control for each of 1^{st} and 2^{nd} pumps P1-P2 is executed, and target discharge pressures P*p1-P*p2 are calculated. Then, the routine proceeds to step S800.

At step S800, pulse-width modulated (PWM) duty cycle values for 1^{st} and 2^{nd} motors M1-M2, corresponding to the respective target discharge pressures P*p1-P*p2, are calculated by way of discharge-pressure-to-speed conversion and voltage-to-duty conversion (pulse-duration modulation). Thereafter, the routine proceeds to step S900.

At step S900, pulse signals corresponding to the calculated PWM duty cycle values for 1^{st} and 2^{nd} motors M1-M2 are outputted. In this manner, one execution cycle of pump backflow prevention control processing based on discharge pressure control terminates.

(Discharge Pressure Falling-Gradient Calculation Flow)

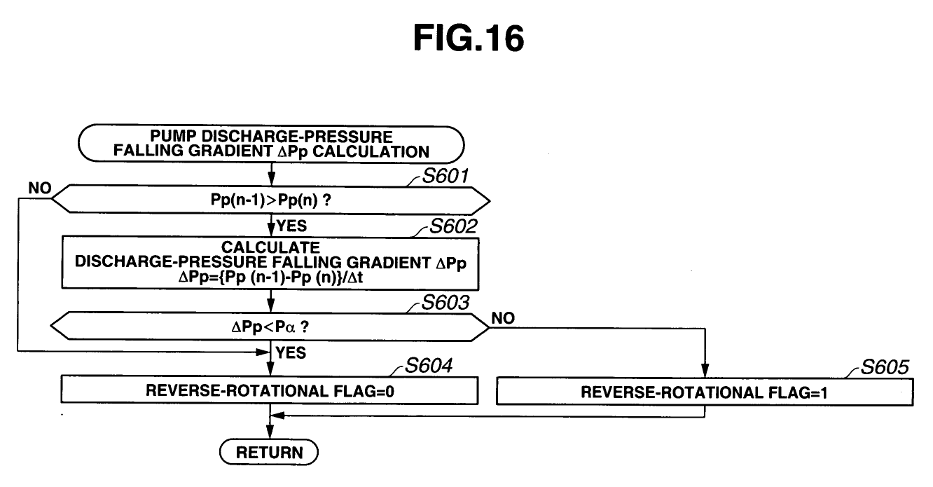

Referring now to FIG. 16, there is shown the pump discharge pressure falling-gradient calculation routine related to step S600 of FIG. 15. The discharge pressure falling-gradient arithmetic processing is executed within discharge-pressure falling gradient calculation sections 121′-221′. As used hereafter, the previous value Pp1(n−1) of 1^{st} pump discharge pressure Pp1 and the previous value Pp2(n−1) of 2^{nd} pump discharge pressure Pp2 are collectively referred to as “the previous value Pp(n−1) of pump discharge pressure Pp”, and the current value Pp1(n) of 1^{st} pump discharge pressure Pp1 and the current value Pp2(n) of 2^{nd} pump discharge pressure Pp2 are collectively referred to as “the current value Pp(n) of pump discharge pressure Pp”.

At step S601, a check is made to determine whether the previous value Pp(n−1) of pump discharge pressure Pp is greater than or equal to the current value Pp(n). When the answer to step S601 is affirmative (YES), that is, when Pp(n−1)>Pp(n), the routine proceeds to step S602. Conversely when the answer to step S601 is negative (NO), that is, when Pp(n−1)≦Pp(n), the routine proceeds to step S604. The inequality Pp(n−1)≦Pp(n) means that the discharge pressure Pp tends to build up but not to fall. Under the condition of Pp(n−1)≦Pp(n), it is unnecessary to calculate discharge-pressure falling gradient ΔPp, and at once one cycle of discharge-pressure falling-gradient calculation routine terminates.

At step S602, 1^{st} pump discharge-pressure falling gradient ΔPp1 and 2^{nd} pump discharge-pressure falling gradient ΔPp2 are calculated from the following expressions.

ΔPp1={Pp1(n−1)−Pp1(n)}/Δt, ΔPp2={Pp2(n−1)−Pp2(n)}/Δt

### Thereafter, the routine proceeds to step S603.

At step S603, a check is made to determine whether the calculated discharge-pressure falling gradient ΔPp is less than predetermined threshold value Pα. When the answer to step S603 is affirmative (i.e., ΔPp<Pα), it is determined that the pump is conditioned in the normal-rotational state, and thus the routine proceeds to step S604. Conversely when the answer to step S603 is negative (i.e., ΔPp≧Pα), it is determined that the pump is conditioned in the reverse-rotational state, and thus the routine proceeds to step S605.

At step S604, a reverse-rotational flag is reset to “0”.

At step S605, the reverse-rotational flag is set to “1”.

When the reverse-rotational flag is reset (=0) through step S604 or when the reverse-rotational flag is set (=1) through step S605, one execution cycle of the discharge pressure falling-gradient calculation routine terminates.

(Pump Discharge Pressure Control Flow)

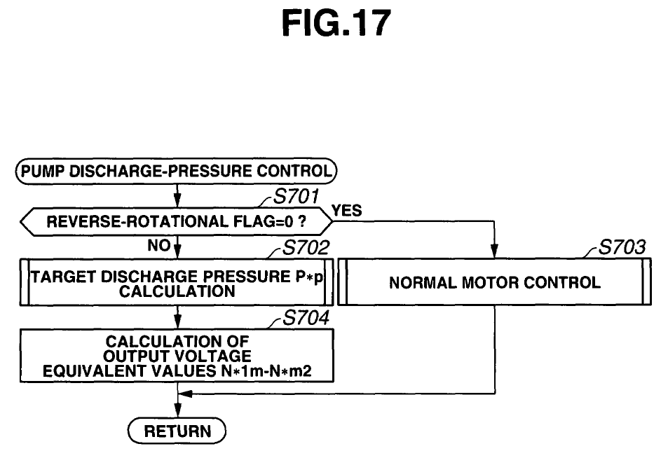

Referring now to FIG. 17, there is shown the pump discharge pressure control routine related to step S700 of FIG. 15. The discharge pressure control processing is executed within pump discharge pressure control sections 122′-222′ and discharge-pressure-to-speed conversion sections 123′-223′.

At step S701, a check is made to determine whether the reverse-rotational flag is reset (=0). When the answer to step S701 is affirmative (with the reverse-rotational flag reset to “0”), the routine proceeds to step S703. Conversely when the answer to step S701 is negative (with the reverse-rotational flag set to “1”), the routine proceeds to step S702.

At step S702, 1^{st} pump target discharge pressure P*p1 and 2^{nd} pump target discharge pressure P*p2 are calculated, and then the routine proceeds to step S704.

At step S703, normal motor control for each of 1^{st} and 2^{nd} motors M1-M2 is executed, since it is unnecessary to execute pump backflow prevention control.

At step S704, output voltage equivalent values N*m1-N*m2 for 1^{st} and 2^{nd} motors M1-M2 are calculated. In this manner, one execution cycle of the discharge pressure control processing terminates.

[Effects of the Modified System]

(4) In the modified brake control apparatus of FIGS. 12-17, 1^{st} pump discharge pressure Pp1 and 2^{nd} pump discharge pressure Pp2 are detected, and then each of 1^{st} pump discharge pressure falling-gradient ΔPp1 and 2^{nd} pump discharge pressure falling-gradient ΔPp2 is compared to predetermined threshold value Pα. When discharge pressure falling-gradient ΔPp becomes greater than or equal to threshold value Pα (that is, when ΔPp≧Pα), it is estimated or determined that reverse rotation of the pump occurs. As discussed above, in the modified brake control apparatus, reverse rotation of the pump can be determined or estimated based on the comparison result of discharge-pressure falling gradient ΔPp and threshold value Pα without using the positional information from position detectors PS1-PS2. Thus, the modified brake control apparatus of FIGS. 12-17 can provide the same effects as the brake control apparatus of the embodiment shown in FIGS. 1-9.

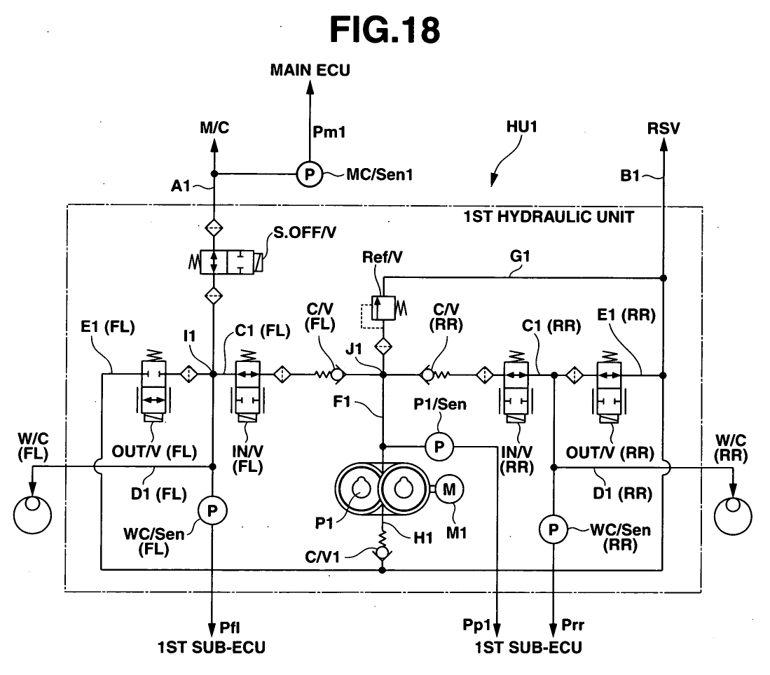

Referring now to FIG. 18, there is shown a modification in which a first one-way check valve C/V1 is disposed in suction line H1 of 1^{st} pump P1 in 1^{st} hydraulic unit HU1 and located upstream of a 1^{st} pump inlet port. Although it is not shown, in a similar manner to 1^{st} hydraulic unit HU1, a second one-way check valve C/V2 is disposed in suction line H2 of 2^{nd} pump P2 in 2^{nd} hydraulic unit HU2 and located upstream of a 2^{nd} pump inlet port. As used hereafter, 1^{st} and 2^{nd} check valves C/V1-C/V2 are collectively referred to as “check valve C/V”. As can be seen from the circuit diagram of FIG. 18, check valve C/V permits free flow in one direction from the suction side (i.e., suction line H) to the discharge side (i.e., discharge line F) and suppresses or prevents any flow in the opposite direction from the discharge side (i.e., discharge line F) to the suction side (i.e., suction line H). That is, in the previously-described brake control apparatus of the embodiment of FIGS. 1-9 and the modified brake control apparatus of FIGS. 12-17, undesirable pump backflow can be controllably prevented or suppressed by way of the pump backflow prevention control system (pump reverse-rotation suppression control system). In contrast, the brake control apparatus of the modification shown in FIG. 18 can prevent undesirable pump backflow or suppress undesirable pump reverse-rotation mechanically by means of check valves C/V1-C/V2, rather than controllably. In the case of the modification shown in FIG. 18, as demerits, check valve C/V disposed in suction line H functions as a hydraulic-system component that increases a fluid-flow resistance coefficient of the suction-side conduit. As merits, the provision of check valves C/V1-C/V2 requires only a simple design change, while ensuring the same backflow-prevention effects as the apparatus of the embodiment of FIGS. 1-9 and the modified brake control apparatus of FIGS. 12-17.

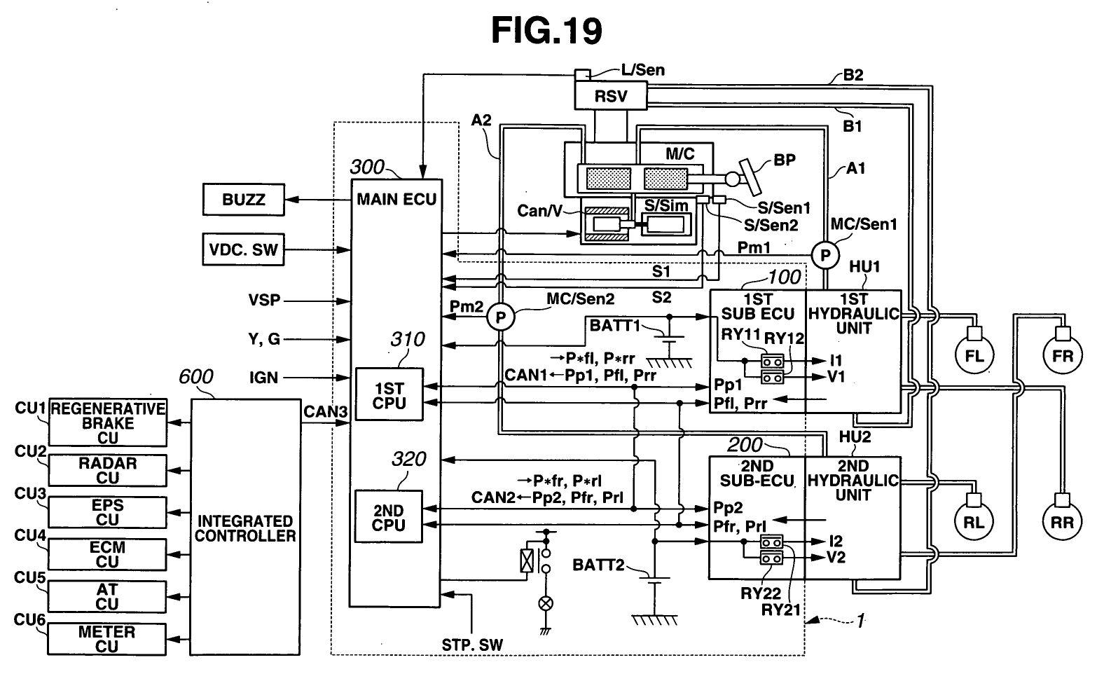

Referring now to FIG. 19, there is shown another modification in which an integrated controller 600 is combined with the brake control apparatus of the embodiment as shown in FIGS. 1-9. Integrated controller 600 is capable of performing regenerative cooperative brake control for a regenerative cooperative brake system, and integrated vehicle control for an integrated vehicle control system, and/or an intelligent transport system (ITS). Even with integrated controller 600 combined with the brake control apparatus of the embodiment as shown in FIGS. 1-9, the brake control system can be independently controlled separately from the other control systems. Thus, it is possible to ensure or realize a high brake control responsiveness while smoothly easily planning fusion with integrated controller 600, without making special proceedings on the brake control system.

In the shown embodiment, each of pump motors M1-M2 is comprised of a brushless motor. In lieu thereof, a brush motor may be used. As a fluid-pressure source, the hydraulic brake control system may use pressure accumulators in addition to pumps P1-P2.

The entire contents of Japanese Patent Application No. 2006-172922 (filed Jun. 22, 2006) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A brake control apparatus comprising:
wheel-brake cylinders mounted on respective road wheels;
a pump that supplies a fluid pressure to each of the wheel-brake cylinders by normal rotation of the pump;
a control unit that controls rotational motion of the pump to bring an actual wheel-cylinder pressure of each of the wheel-brake cylinders closer to a target wheel-cylinder pressure; and
a pump reverse-rotation suppression device that suppresses reverse rotation of the pump.

2. The brake control apparatus as claimed in claim 1, wherein:
the pump reverse-rotation suppression device comprises a one-way check valve disposed in a suction line of the pump and located upstream of an inlet port of the pump for permitting only a free flow in one direction from a pump suction side to a pump discharge side.

3. The brake control apparatus as claimed in claim 1, wherein:
the pump reverse-rotation suppression device comprises:
(1) a rotational-direction detector that detects a rotational direction of the pump; and
(2) a pump control circuit that suppresses the reverse rotation of the pump, only when the detected rotational direction of the pump is opposite to a normal-rotational direction of the rotational motion of the pump controlled by the control unit.

4. The brake control apparatus as claimed in claim 3, wherein:
the pump reverse-rotation suppression device switches a control gain to a reverse-rotational period control gain differing from a normal control gain, only when the reverse rotation of the pump has been detected.

5. The brake control apparatus as claimed in claim 3, wherein:
the rotational-direction detector of the pump reverse-rotation suppression device determines, based on a rotational direction of a driven shaft of the pump, whether the pump rotates in a reverse-rotational direction.

6. The brake control apparatus as claimed in claim 5, wherein:
the pump comprises a brushless-motor equipped pump; and
the rotational-direction detector comprises a position sensor that detects an angular position of a brushless-motor rotor.

7. The brake control apparatus as claimed in claim 3, wherein:
the rotational-direction detector of the pump reverse-rotation suppression device comprises a pressure sensor that detects a discharge pressure of the pump; and
the rotational-direction detector estimates that the reverse rotation of the pump occurs, when a supply of the fluid pressure to each of the wheel-brake cylinders by the pump is stopped and a falling gradient of the detected discharge pressure becomes greater than or equal to a predetermined threshold value.

8. A brake control apparatus employing a tandem master cylinder and a pair of hydraulic units, each hydraulic unit having a pump producing a fluid pressure independently of the master cylinder, a hydraulic circuit having a first flow path communicating an associated one of two port outlets of the master cylinder with an associated one of front wheel-brake cylinders via a first directional control valve and a second flow path introducing the fluid pressure produced by the pump to an associated one of rear wheel-brake cylinders as well as the associated one of the front wheel-brake cylinders directly via a second directional control valve, the brake control apparatus comprising:
a control unit that switches between a first fluid-pressure supply that a master-cylinder pressure is supplied from the master cylinder to the associated front wheel-brake cylinder via the first directional control valve and a second fluid-pressure supply that the fluid pressure produced by normal rotation of the pump is supplied to the associated wheel-brake cylinders directly via the second directional control valve, by controlling open and closed operation of each of the first and second directional control valves; and
a pump reverse-rotation suppression device that suppresses reverse rotation of the pump.

9. The brake control apparatus as claimed in claim 8, wherein:
the pump reverse-rotation suppression device comprises a one-way check valve disposed in a suction line of the pump and located upstream of an inlet port of the pump for permitting only a free flow in one direction from a pump suction side to a pump discharge side.

10. The brake control apparatus as claimed in claim 8, wherein:
the pump reverse-rotation suppression device comprises:
(1) a rotational-direction detector that detects a rotational direction of the pump; and
(2) a pump control circuit that suppresses the reverse rotation of the pump, only when the detected rotational direction of the pump is opposite to a normal-rotational direction of rotational motion of the pump controlled by the control unit.

11. The brake control apparatus as claimed in claim 10, wherein:
the pump reverse-rotation suppression device switches a control gain to a reverse-rotational period control gain differing from a normal control gain, only when the reverse rotation of the pump has been detected.

12. The brake control apparatus as claimed in claim 10, wherein:
the rotational-direction detector of the pump reverse-rotation suppression device determines, based on a rotational direction of a driven shaft of the pump, whether the pump rotates in a reverse-rotational direction.

13. The brake control apparatus as claimed in claim 12, wherein:
the pump comprises a brushless-motor equipped pump; and
the rotational-direction detector comprises a position sensor that detects an angular position of a brushless-motor rotor.

14. The brake control apparatus as claimed in claim 10, wherein:
the rotational-direction detector of the pump reverse-rotation suppression device comprises a pressure sensor that detects a discharge pressure of the pump; and
the rotational-direction detector estimates that the reverse rotation of the pump occurs, when the second fluid-pressure supply is stopped and a falling gradient of the detected discharge pressure becomes greater than or equal to a predetermined threshold value.

15. The brake control apparatus as claimed in claim 10, wherein:
the pump reverse-rotation suppression device controls the rotational motion of the pump to a stopped state.

16. The brake control apparatus as claimed in claim 10, wherein:
the pump reverse-rotation suppression device controls the rotational motion of the pump to a rotational direction opposite to the detected rotational direction.

17. The brake control apparatus as claimed in claim 11, wherein:
the pump reverse-rotation suppression device controls the rotational motion of the pump to a stopped state.

18. The brake control apparatus as claimed in claim 11, wherein:
the pump reverse-rotation suppression device controls the rotational motion of the pump to a rotational direction opposite to the detected rotational direction.

19. A brake control method comprising:
providing a first fluid-pressure supply mode at which a master-cylinder pressure, produced based on a driver's brake-pedal depression, is supplied from a master cylinder to each of front wheel-brake cylinders;
providing a second fluid-pressure supply mode at which a fluid pressure produced by normal rotation of a pump, which pump produces the fluid pressure independently of the master cylinder, is supplied to an associated one of rear wheel-brake cylinders as well as an associated one of the front wheel-brake cylinders;
selectively switching from one of the first and second fluid-pressure supply modes to the other depending on whether a brake system is failed or unfailed; and
engaging a pump reverse-rotation suppressing function that suppresses reverse rotation of the pump by suppressing working-fluid flow from each of the wheel-brake cylinders to a pump suction side, only when the reverse rotation of the pump occurs.

20. The brake control method as claimed in claim 19, wherein:
the pump reverse-rotation suppressing function includes a rotational-direction detecting function that detects a rotational direction of the pump; and
the pump reverse-rotation suppressing function is engaged to suppress the reverse rotation of the pump by switching a control gain to a reverse-rotational period control gain differing from a normal control gain, only when the detected rotational direction of the pump is opposite to a normal-rotational direction of rotational motion of the pump controlled by a control unit.
